(19) United States
(12) Patent Application Publication
(10) Pub. No.: US 2026/0370806 A1
(43) Pub. Date: Nov. 19, 2026

(54) ENCODING METHOD, DECODING METHOD, ENCODER, DECODER, CODE STREAM, AND STORAGE MEDIUM

(71) Applicant: GUANGDONG OPPO MOBILE TELECOMMUNICATIONS CORP., LTD., Dongguan (CN)

(72) Inventor: Luhang XU, Dongguan (CN)

(73) Assignee: GUANGDONG OPPO MOBILE TELECOMMUNICATIONS CORP., LTD., Dongguan (CN)

(21) Appl. No.: 19/734,953

(22) Filed: Jul. 8, 2026

Related U.S. Application Data
(63) Continuation of application No. PCT/CN2024/072599, filed on Jan. 16, 2024.

(30) Foreign Application Priority Data
Jan. 9, 2024 (WO) PCT/CN2024/071312

(51) Int. Cl. H04N 19/105; H04N 19/136; H04N 19/176; H04N 19/70

(52) U.S. Cl. CPC H04N 19/105; H04N 19/136; H04N 19/176; H04N 19/70

(57) ABSTRACT

A decoding method includes: first information is determined, where the first information is used for indicating whether non-separable transform is used for a current transform block; neighbouring information of the current transform block is determined according to the first information; and a coefficient of the current transform block is determined according to the neighbouring information.

### CROSS-REFERENCE TO RELATED APPLICATIONS

This application is a continuation application of International Patent Application No. PCT/CN2024/072599 filed on Jan. 16, 2024, which claims priority to Chinese Patent Application No. PCT/CN2024/071312 filed with the China National Intellectual Property Administration on Jan. 9, 2024. The contents of these applications are hereby incorporated by reference in their entireties.

### BACKGROUND

Redundant information of residual information can be removed by a transform operation to improve compression performance of a video. A non-separable transform operation is an important transform operation. However, current encoding and decoding manners for the non-separable transform operation are sometimes unreasonable and may degrade the encoding and decoding performance.

### SUMMARY

The disclosure relates to the technical field of video coding, and provides an encoding method, a decoding method, an encoder, a decoder, a bitstream and a storage medium. Various aspects of the disclosure are described below.

In a first aspect, there is provided a decoding method, applied to a decoder. The decoding method includes: determining first information, the first information being used for indicating whether non-separable transform is used for a current transform block; determining neighbouring information of the current transform block according to the first information; and determining a coefficient of the current transform block according to the neighbouring information.

In a second aspect, there is provided an encoding method, applied to an encoder. The encoding method includes: determining first information, the first information being used for indicating whether non-separable transform is used for a current transform block; determining neighbouring information of the current transform block according to the first information; and encoding a coefficient of the current transform block according to the neighbouring information.

In a third aspect, there is provided a non-transitory computer-readable storage medium having stored thereon a computer program and a bitstream. When the computer program is executed by a processor, the computer program implements a decoding method to decode the bitstream to generate a video or an image. The decoding method includes: first information is determined, where the first information is used for indicating whether non-separable transform is used for a current transform block; neighbouring information of the current transform block is determined according to the first information; and a coefficient of the current transform block is determined according to the neighbouring information.

### BRIEF DESCRIPTION OF THE DRAWINGS

FIG. 1 is an exemplary structural diagram of a video encoder to which an embodiment of the disclosure is applicable.

FIG. 2 is an exemplary structural diagram of a video decoder to which an embodiment of the disclosure is applicable.

FIG. 3 is an exemplary diagram of LFNST transform and inverse transform processes.

FIG. 4 is an exemplary diagram of two kinds of neighbouring information.

FIG. 5 is a schematic flowchart of a decoding method according to an embodiment of the disclosure.

FIG. 6 is a schematic flowchart of an encoding method according to an embodiment of the disclosure.

FIG. 7 is a schematic flowchart for determining neighbouring information according to an embodiment of the disclosure.

FIG. 8 is another schematic flowchart for determining neighbouring information according to an embodiment of the disclosure.

FIG. 9 is another schematic flowchart for determining neighbouring information according to an embodiment of the disclosure.

FIG. 10 is another schematic flowchart for determining neighbouring information according to an embodiment of the disclosure.

FIG. 11 is a schematic diagram for determining a histogram of gradient according to an embodiment of the disclosure.

FIG. 12 is a schematic structural diagram of a decoder according to an embodiment of the disclosure.

FIG. 13 is a schematic structural diagram of a decoder according to another embodiment of the disclosure.

FIG. 14 is a schematic structural diagram of an encoder according to an embodiment of the disclosure.

FIG. 15 is a schematic structural diagram of an encoder according to another embodiment of the disclosure.

### DETAILED DESCRIPTION

Hereinafter, technical solutions in the disclosure will be described with reference to the accompanying drawings.

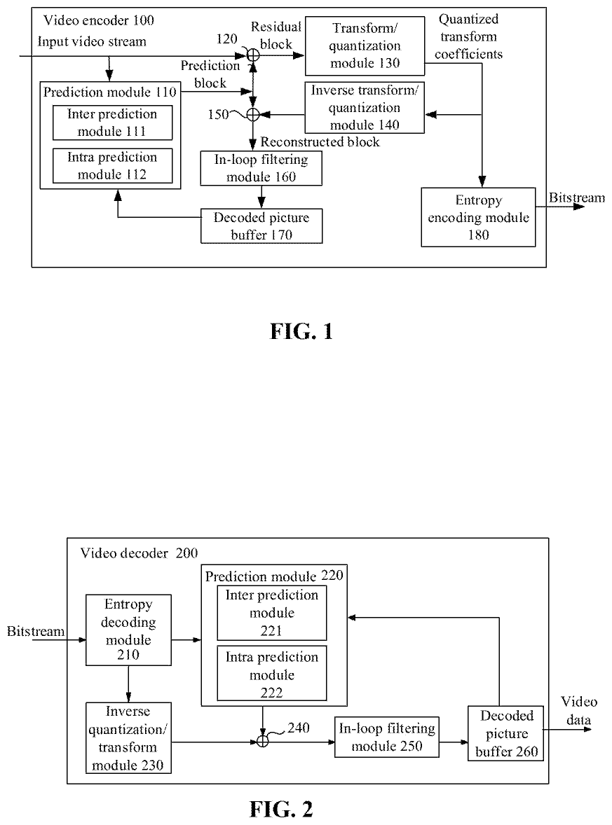

FIG. 1 is a schematic block diagram of a video encoder involved in embodiments of the disclosure.

It is to be understood that the video encoder 100 may be used for lossy compression of a picture as well as for lossless compression of the picture. The lossless compression may be visually lossless compression or mathematically lossless compression.

The video encoder 100 may be applied to picture data in a luma-chroma (YCbCr, YUV) format. For example, the YUV ratio may be 4:2:0, 4:2:2, or 4:4:4, where Y represents luma, Cb (U) represents blue chroma, Cr (V) represents red chroma, and U and V represent chroma for describing colour and saturation. For example, in the colour format, 4:2:0 indicates that there are 4 luma components and 2 chroma components (YYYYCbCr) per 4 pixels; 4:2:2 indicates that there are 4 luma components and 4 chroma components (YYYYCbCrCbCr) per 4 pixels; and 4:4:4 indicates full-pixel display (YYYYCbCrCbCrCbCrCbCr).

For example, the video encoder 100 reads video data, and partitions each picture in the video data into several Coding Tree Units (CTUs). and in some examples, the CTU may be referred to as a “tree block”, a “Largest coding unit” (LCU), or a “Coding Tree Block” (CTB). Each CTU may be associated with a sample block having a same size within the picture. Each sample may correspond to one luma (or luminance) sample and two chroma (or chrominance) samples. Thus, each CTU may be associated with one luma sample block and two chroma sample blocks. The size of one CTU is, for example, 128×128, 64×64, 32×32, or the like. One CTU may be further partitioned into several Coding Units (CUs) for coding, which may be rectangular or square blocks. The CU may correspond to a Prediction Unit (PU) and a Transform Unit (TU).

In some embodiments, as shown in FIG. 1, the video encoder 100 may include a prediction module 110, a residual module 120, a transform/quantization module 130, an inverse transform/quantization module 140, a reconstruction module 150, a in-loop filtering module 160, a decoded picture buffer 170, and an entropy encoding module 180. It is to be noted that the video encoder 100 may include more, fewer, or different functional components.

Optionally, in the disclosure, the current block may be referred to as a current Coding Unit (CU). The prediction block may also be referred to as a prediction picture block or a picture prediction block, and a reconstructed picture block may also be referred to as a reconstructed block or a picture-reconstruction block. Due to the need for parallel processing, the picture may be partitioned into slices. Slices in the same picture may be processed in parallel, that is, there is no data dependency between them. The term “frame” is a commonly used term, and as generally understood, one frame is one picture. The frames described herein may also be replaced with pictures or slices, or the like.

In some embodiments, the prediction module 110 includes an inter prediction module 111 and an intra prediction module 112. Because there is a strong correlation between neighbouring samples in one picture of a video, the intra prediction method is used to eliminate spatial redundancy between neighbouring samples in the video encoding and decoding technology. Because of the strong similarity between neighbouring pictures in the video, the inter prediction method is used to eliminate temporal redundancy between neighbouring pictures in the video encoding and decoding technology, thus improving the coding efficiency.

The inter prediction module 111 may be used for inter prediction, which may include motion estimation and motion compensation. Picture information of different pictures may be referred to. In inter prediction, motion information is used to find a reference block from a reference picture, and a prediction block is generated according to the reference block, so as to eliminate temporal redundancy. The motion information includes a reference picture list where the reference picture is located, a reference picture index, and a motion vector. The motion vector may be of an integer sample or a fractional sample. If the motion vector is of a fractional sample, interpolation filtering is required to be performed in a reference picture to generate a required fractional sample block. Herein, an integer sample block or a fractional sample block found in a reference picture according to a motion vector is referred to as a reference block. In some technologies, the reference block is directly used as a prediction block, and in some technologies, the reference block is further processed to generate the prediction block. Generating the prediction block by processing the reference block can also be understood as treating the reference block as an prediction block, and then further processing the prediction block to generate a new prediction block.

The intra prediction module 112 predicts sample information within a current picture block by referencing only information of the same picture, so as to eliminate spatial redundancy.

There are many prediction modes for intra prediction. Taking the H-series of international digital video coding standards as an example, the H.264/AVC standard includes 8 angular prediction modes and 1 non-angular prediction mode, and the H.265/HEVC standard is extended to include 33 angular prediction modes and 2 non-angular prediction modes. The intra prediction modes used by High Efficiency Video Coding (HEVC) include Planar mode (Planar), DC mode (DC) and 33 angular modes, with a total of 35 prediction modes. The intra modes used by Versatile Video Coding (VVC) are Planar, DC and 65 angular modes, with 67 prediction modes in total.

It is to be noted that as the number of angular modes increases, intra prediction becomes more accurate, which complies better with the development demands of high-definition and ultra-high-definition digital videos.

The residual module 120 may generate a residual block of the CU based on the sample block of the CU and the prediction block of the CU. For example, the residual module 120 may generate a residual block of the CU such that each sample in the residual block has a value equal to a difference between a sample in the sample block of the CU and a corresponding sample in the prediction block of the CU.

The transform/quantization module 130 may quantize the transform coefficients. The transform/quantization module 130 may quantize transform coefficients associated with the CU based on Quantization Parameter (QP) values associated with the CU. The video encoder 100 may adjust the degree of quantization applied to the transform coefficients associated with the CU by adjusting the QP values associated with the CU.

The inverse transform/quantization module 140 may apply inverse quantization and inverse transform to the quantized transform coefficients, respectively, to reconstruct a residual block from the quantized transform coefficients.

The reconstruction module 150 may add samples of the reconstructed residual blocks to corresponding samples of one or more prediction blocks generated by the prediction module 110 to produce a reconstructed picture block associated with the CU. By reconstructing each sample block of the CU in this manner, the video encoder 100 may reconstruct the sample block of the CU.

The in-loop filtering module 160 is used for processing the samples subjected to inverse transform and inverse quantization, compensating for distortion information, and providing a better reference for subsequent coding samples. For example, a deblocking filtering operation may be performed to reduce blocking artifacts of a sample block associated with a CU.

In some embodiments, the in-loop filtering module 160 includes a deblocking filtering module and a Sample Adaptive Offset/Adaptive Loop Filtering (SAO/ALF) module, where the deblocking filtering module is used to deblock the blocking artifacts and the SAO/ALF module is used to remove ringing artifacts.

The decoded picture buffer 170 may store the reconstructed sample block. The inter prediction module 111 may perform inter prediction on PUs of other pictures using the reference picture containing the reconstructed sample block. In addition, the intra prediction module 112 may use the reconstructed sample block in the decoded picture buffer 170 to perform intra prediction on other PUs in the same picture as the CU.

The entropy coding module 180 may receive the quantized transform coefficients from the transform/quantization module 130. The entropy coding module 180 may perform one or more entropy coding operations on the quantized transform coefficients to generate entropy coded data.

FIG. 2 is a schematic block diagram of a video decoder involved in embodiments of the disclosure.

As shown in FIG. 2, the video decoder 200 includes an entropy decoding module 210, a prediction module 220, an inverse quantization/transform module 230, a reconstruction module 240, an in-loop filtering module 250, and a decoded picture buffer 260. It is to be noted that the video decoder 200 may include more, fewer, or different functional components.

The video decoder 200 may receive a bitstream. The entropy decoding module 210 may parse the bitstream to extract syntax elements from the bitstream. As part of parsing the bitstream, the entropy decoding module 210 may parse entropy-encoded syntax elements in the bitstream. The prediction module 220, the inverse quantization/transform module 230, the reconstruction module 240 and the in-loop filtering module 250 may decode the video data according to the syntax elements extracted from the bitstream, i.e., generate decoded video data.

In some embodiments, the prediction module 220 includes an intra prediction module 222 and an inter prediction module 221.

The intra prediction module 222 may perform intra prediction to generate a prediction block of a PU. The intra prediction module 222 may use an intra prediction mode to generate a prediction block of the PU based on a sample block of a spatially neighbouring PU. The intra prediction module 222 may also determine the intra prediction mode of the PU based on one or more syntax elements parsed from the bitstream.

The inter prediction module 221 may construct a first reference picture list (List 0) and a second reference picture list (List 1) according to syntax elements parsed from the bitstream. Further, if the PU uses inter prediction coding, the entropy decoding module 210 may parse motion information of the PU. The inter prediction module 221 may determine one or more reference blocks of the PU according to the motion information of the PU. The inter prediction module 221 may generate a prediction block of the PU according to one or more reference blocks of the PU.

The inverse quantization/transform module 230 reversibly quantizes (i.e., de-quantizes) transform coefficients associated with a TU. The inverse quantization/transform module 230 may use a QP value associated with a CU of the TU to determine a degree of quantization.

After inversely quantizing the transform coefficients, the inverse quantization/transform module 230 may apply one or more inverse transforms to the inversely quantized transform coefficients to generate a residual block associated with the TU.

The reconstruction module 240 uses the residual block associated with the TU of the CU and the prediction block of the PU of the CU to reconstruct a sample block of the CU. For example, the reconstruction module 240 may add a sample of the residual block to a corresponding sample of the prediction block to reconstruct the sample block of the CU, resulting in a reconstructed picture block.

The in-loop filtering module 250 may perform an deblocking filtering operation to reduce blocking artifacts of a sample block associated with a CU.

The video decoder 200 may store the reconstructed picture of the CU in the decoded picture buffer 260. The video decoder 200 may use the reconstructed picture in the decoded picture buffer 260 as a reference picture for subsequent prediction, or transmit the reconstructed picture to a display device for presentation.

The basic flow of video encoding and decoding is as follows: at the encoding end, one picture is partitioned into blocks, and for a current block, the prediction module 110 generates a prediction block of the current block using intra prediction or inter prediction. The residual module 120 may calculate a residual block, i.e. a difference between a prediction block and an original block of the current block, based on the prediction block and the original block of the current block. The residual block may also be referred to as residual information. The residual block can be transformed and quantized by the transform/quantization module 130, and information that is insensitive to the human eye can be removed to eliminate visual redundancy. Optionally, a residual block before being transformed and quantized by the transform/quantization module 130 may be referred to as a time-domain residual block, and a time-domain residual block after being transformed and quantized by the transform/quantization module 130 may be referred to as a frequency residual block or a frequency-domain residual block. The entropy encoding module 180 receives quantized transform coefficients output by the transform/quantization module 130, entropy encodes the quantized transform coefficients, and outputs a bitstream. For example, the entropy encoding module 180 may eliminate character redundancy according to a target context model and probability information of the binary bitstream.

At the decoding end, the entropy decoding module 210 can parse the bitstream to obtain prediction information, a quantization coefficient matrix and the like of the current block, and the prediction module 220 generates a prediction block of the current block by using intra prediction or inter prediction for the current block based on the prediction information. The inverse quantization/transform module 230 performs inverse quantization and inverse transform on a quantization coefficient matrix obtained from the bitstream to obtain a residual block. The reconstruction module 240 adds the prediction block and the residual block to obtain a reconstructed block. The reconstructed blocks constitute a reconstructed picture, and the in-loop filtering module 250 performs in-loop filtering on the reconstructed picture based on the picture or based on the block to obtain a decoded picture. The encoding end also needs to perform operations similar to those of the decoding end to obtain a decoded picture. The decoded picture may also be referred to as a reconstructed picture, and the reconstructed picture may serve as a reference picture for a subsequent picture for inter-prediction.

It is to be noted that the block partition information determined by the encoding end, and mode information or parameter information relating to prediction, transform, quantization, entropy coding and in-loop filtering, are carried in the bitstream when necessary. The decoding end, by parsing the bitstream and analyzing based on available information, determines the same block partition information and mode information or parameter information relating to prediction, transform, quantization, entropy coding and in-loop filtering as the encoding end, thereby ensuring that the decoded picture obtained at the encoding end is identical to that obtained at the decoding end.

It is to be be understood that the “inverse transform” of the transform coefficients by the decoding end may also be referred to as a “transform” in the the text of the standard. “Transform” and “inverse transform” in the embodiments of the disclosure correspond to two opposite processes. For example, “transform” converts a numerical value in the spatial domain to a coefficient in the frequency domain, and “inverse transform” converts a coefficient in the frequency domain to a numerical value in the spatial domain. If the standard only specifies decoding, then “transform” in the text of the standard is a part of decoding and refers to the “inverse transform” in the present disclosure. The “inverse transform” of the transform coefficients by the decoding end may also be referred to as a “transform” in the the text of the standard.

The above is the basic workflow of a video codec under a block-based hybrid coding framework. With the development of technology, some modules or steps of the framework or workflow may be optimized. The present disclosure is applicable to the basic workflow of the video codec under the block-based hybrid coding framework, but is not limited to the framework and workflow.

The encoding and decoding framework provided in the embodiments of the present disclosure has been described in detail above. The disclosure relates to the transform technology The transform technology can be applied to the transform/inverse transform module in the encoding and decoding framework The transform technology involved in the present disclosure is introduced below.

### Dual Tree (DT) Partition

As can be seen from the foregoing, the encoder and decoder in the embodiments of the disclosure can be applied to picture data in a luma-chroma (YCbCr, YUV) format. Typically, there is a significant difference between picture details contained in the luma component and the chroma component. The luma component possesses a large amount of detail information, whereas the chroma component carries less information and appears relatively smooth. Therefore, the luma component is more suitable for being partitioned into smaller blocks in most cases to represent more details; conversely, the chroma component does not require fine partitioning in most cases.

In the Versatile Video Coding (VVC) standard, a partitioning technology with different partitions for a luma component and a chroma component is adopted, namely, a Dual Tree (DT) partitioning technology. The DT partitioning technology is applied to intra-coded pictures. For intra-coded pictures, different partition schemes may be used for the luma component and the chroma component. Starting from each coding tree unit, the luma component uses a luma partitioning tree, and the chroma component uses a chroma partitioning tree. Since the luma component and the chroma component have their respective coding tree units, the luma component and the chroma component also have their respective coding units.

For an inter-coded picture or a coded picture to which the DT partition scheme is not applicable, the luma component and the chroma component do not use different partition trees, and one coding unit includes a luma block and a chroma block.

### Karhunen-Loève (K-L) Transform

The K-L transform is named after Kari Karhunen and Michel Loève. The K-L transform is an orthogonal transform of an input vector X, so that an output vector can remove the correlation of the data.

The K-L transform is a transform established based on statistical characteristics, and is the optimal transform in terms of mean square error (MSE). Therefore, it occupies an important position in data compression technology.

Although the K-L transform is the optimal transform in terms of MSE, the input signal must be known in advance, and a series of cumbersome mathematical operations, such as the computation of covariance and eigenvectors, are required. Therefore, the K-L transform is not widely used in practical engineering. Nevertheless, the K-L transform is theoretically the optimal method; therefore, when searching for transform methods that are sub-optimal but easier to implement, the K-L transform can provide an evaluation criterion for assessing transform performance.

Taking image processing as an example, in the K-L transform, the energy of an image becomes concentrated, thereby contributing to image compression. However, in practice, the K-L transform is input-dependent, which means that a transform mechanism needs to be stored for each input picture, and the transform mechanism varies from picture to picture. This is impractical for practical applications.

### Non-Separable Transform

The non-separable transform refers to a two-dimensional transform that cannot be decomposed into two one-dimensional transforms in the horizontal and vertical directions. The non-separable transform in the disclosure may include Low-Frequency Non-Separable Transform (LFNST) and Non-Separable Primary Transform (NSPT). These two transform manners are described below.

The LFNST is a transform based on the principle of K-L transform. Due to complexity considerations in VVC, the LFNST is applied to the transform coefficients after the primary transform, and is therefore referred to as a secondary transform. The LFNST may act on the low-frequency coefficients after the primary transform to remove redundant information in the low-frequency coefficients. The primary transform may be, for example, a Discrete Cosine Transform Type-II (DCT-II) transform, and this transform manner may also be referred to as a DCT-II+LFNST transform. In some implementations, the primary transform may also be referred to as a main transform.

In VCC, the LFNST can have two different sized transform kernels. One is a transform kernel with 64-coefficient input and 16-coefficient output, and the other is a transform kernel with 16-coefficient input and 8-coefficient output. Transform kernels of different sizes may be adapted to transform blocks of different sizes. For example, a transform kernel with a 64-coefficient input is suitable for transform blocks of size greater than or equal to 8×8, and a transform kernel with a 16-coefficient input is suitable for transform blocks of other sizes, such as 4×4. The 64-coefficient input transform kernel may also be referred to as a large-size transform kernel, and the 16-coefficient input transform kernel may also be referred to as a small-size transform kernel.

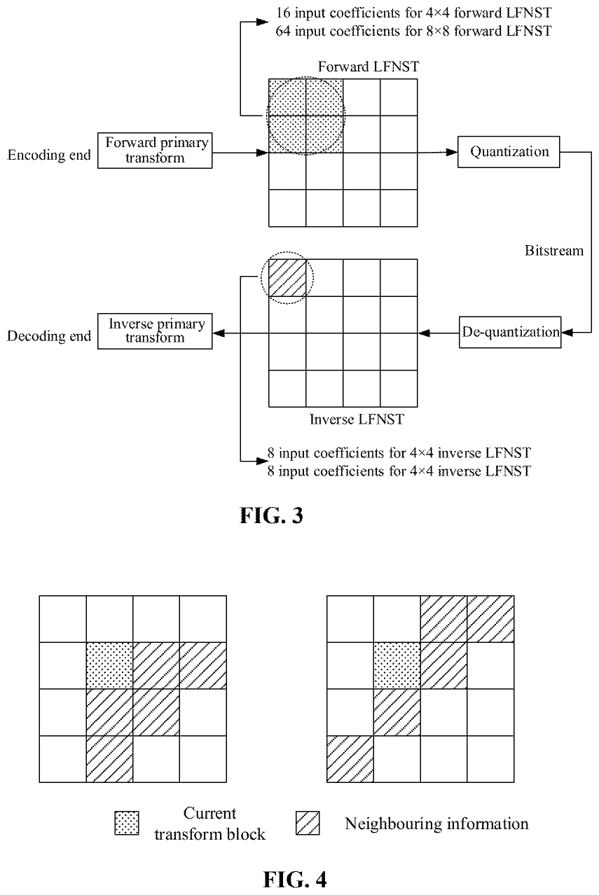

Hereinafter, the transform and inverse transform flows of the LFNST will be described with reference to FIG. 3.

At the encoding end, the residual information may be transformed using a forward primary transform and the LFNST. For example, the forward primary transform may be performed on the residual information to obtain a first coefficient, and then the first coefficient is transformed using the LFNST to obtain a transformed coefficient. When the LFNST is used, 64 coefficients in the top-left 8×8 region may be taken as the input for the large-size transform kernel, or the 16 coefficients in the top-left 4×4 region may be taken as the input for the small-size transform kernel, with the remaining regions being set with all-zero coefficients by default. After being processed by the transform kernel, transformed coefficients are generated, and the transformed coefficients are then quantized to yield coefficients of transform blocks. The transformed coefficients are signalled in the bitstream. Similarly, at the decoding side, the coefficients of the transform block can be obtained by parsing the bitstream, the coefficients of the transform block can be inversely quantized to obtain the transformed coefficients, and then the inverse LFNST and the inverse primary transform are performed on the transformed coefficients to obtain the residual information. When the inverse LFNST is performed, 16 positions in a top-left 4×4 region may include an output of the large-size inverse transform kernel, or the first 8 positions in a top-left scanning order may include an output of the small-size inverse transform kernel, and the coefficients at the other positions are 0 by default.

In VCC, the selection of the transform kernel for the LFNST depends not only on the size of the transform block, but also on an intra prediction mode used during prediction of the transform block and an LFNST index parsed from the bitstream. In the implementation process, the LFNST transform coefficients exist in a multi-dimensional array g_lfnstM×N[ ][ ][ ][ ]. Specifically, the first dimension is an index associated with the intra prediction mode, the second dimension is a transform kernel index parsed from the bitstream, and the third and fourth dimensions are transform coefficients.

Table 1 shows correspondences between intra prediction modes and related indexes.

TABLE 1

| IntraPredMode | Tr. set index |
|---|---|
| IntraPredMode <0 | 1 |
| 0 <= IntraPredMode <= 1 | 0 |
| 2 <= IntraPredMode <= 12 | 1 |
| 13 <= IntraPredMode <= 23 | 2 |
| 24 <= IntraPredMode <= 44 | 3 |
| 45 <= IntraPredMode <= 55 | 2 |
| 56 <= IntraPredMode <= 80 | 1 |
| 81 <= IntraPredMode <= 83 | 0 |

In Table 1, IntraPredMode is an intra prediction mode, Tr. set index is an index related to the intra prediction mode. When the intra prediction mode is less than 0, the related index is 1; when the intra prediction mode is greater than or equal to 0 and less than or equal to 1, the related index is 0; when the intra prediction mode is greater than or equal to 2 and less than or equal to 12, the related index is 1; when the intra prediction mode is greater than or equal to 13 and less than or equal to 23, the related index is 2; when the intra prediction mode is greater than or equal to 24 and less than or equal to 44, the related index is 3; when the intra prediction mode is greater than or equal to 45 and less than or equal to 55, the related index is 2; when the intra prediction mode is greater than or equal to 56 and less than or equal to 80, the related index is 1; when the intra prediction mode is greater than or equal to 81 and less than or equal to 83, the related index is 0.

In the Enhanced Compression Model (ECM), some enhancement technologies for LFNST and NSPT technologies are adopted.

Compared to the LFNST technique in VCC, the LFNST enhancement technique includes more transform kernel sizes and finer transform kernel set partitioning. For transform kernel sizes, transform kernels of different sizes may be used for transform blocks greater than or equal to 16×16, transform blocks greater than or equal to 8×8 and less than 16×16, and transform blocks greater than or equal to 4×4 and less than 8×8. Regarding the partitioning of the transform kernel sets, the transform kernels can be divided into 35 sets according to the intra prediction modes; furthermore, based on the transform kernel indexes parsed from the bitstream, the transform kernels can be divided into 3 sets.

The transform principle of the NSPT technique is similar to that of the LFNST technique. The NSPT replaces the original transform manner that uses DCT-II as a primary transform and LFNST as a secondary transform; instead, the NSPT directly utilizes the NSPT primary transform coefficients obtained on a set-by-set basis to perform transform and inverse transform on the residual. In ECM-11.0, the NSPT technique may be applicable to a transform block having a size of 4×4, 4×8, 4×16, 4×32, 8×4, 8×8, 8×16, 8×32, 16×4, 16×8, 32×4, 32×8. The NSPT technique and the LFNST technique have the same set classification and the same number of input and output coefficients. For a transform block size applicable to the NSPT, the NSPT transform coefficients may be directly acquired based on parsed LFNST flags and indexes, so as to replace the original DCT-II+LFNST transform.

Whether the LFNST or NSPT is used may be indicated by an LFNST Identifier (ID). The LFNST ID may be represented by, for example, cu.lfnstIdx or lfnstIdx. The LFNST ID may be an ID at a coding unit level.

Taking the LFNST as an example, if the LFNST ID indicates that LFNST is used, the transform coefficient is obtained after undergoing the primary transform and the LFNST. If the LFNST ID indicates that the LFNST is not used, the transform coefficient is obtained after only undergoing the primary transform. At the encoding end, if the LFNST is used, the transform and quantization module can perform primary transform on the residual information first, and then perform the LFNST, so as to obtain transform coefficients, and after being quantized, the transform coefficients are represented by corresponding IDs, and signalled into the bitstream. At the decoding end, the decoder can obtain the LFNST IDs and the corresponding IDs by parsing the bitstream, and first construct the quantized coefficients. The quantized coefficients undergo inverse quantization to obtain transform coefficients. If the LFNST IDs indicates that LFNST is used, the decoder may first perform inverse LFNST on the transform coefficients, and then perform primary inverse transform, thereby obtaining reconstructed residual information. If the LFNST IDs indicate that the LFNST is not used, the decoder may perform primary inverse transform on the transform coefficients to obtain the reconstructed residual information.

Taking the NSPT as an example, if the LFNST ID indicates that NSPT is used, the transform coefficient is obtained after undergoing the NSPT. If the LFNST ID indicates that the NSPT is not used, the transform coefficient is obtained after only undergoing the primary transform. At the encoding end, if the NSPT is used, the transform and quantization module can perform the NSPT on the residual information first so as to obtain transform coefficients, and after being quantized, the transform coefficients are represented by corresponding IDs, and signalled into the bitstream. At the decoding end, the decoder can obtain the LFNST IDs and the corresponding IDs by parsing the bitstream, and first construct the quantized coefficients. The quantized coefficients undergo inverse quantization to obtain transform coefficients. If the LFNST IDs indicates that NSPT is used, the decoder may perform inverse NSPT on the transform coefficients, thereby obtaining reconstructed residual information. If the LFNST IDs indicate that the NSPT is not used, the decoder may perform inverse primary transform on the transform coefficients to obtain the reconstructed residual information.

As can be seen from the foregoing, for an intra-coded picture, luma and chroma components may use different partition trees. In this case, for a luma transform block, its own LFNST ID may be used to indicate whether the luma transform block uses non-separable transform, and for a chroma transform block, its own LFNST ID may also be used to indicate whether the chroma transform block uses non-separable transform. For an inter-coded picture or a coded picture to which the DT division manner is not applicable, since one coding unit includes both a luma block and a chroma block, in this case, the LFNST ID controls only whether the luma block uses the non-separable transform, and the chroma block does not use the non-separable transform, but only uses the primary transform or the inverse primary transform. For example, if the LFNST ID indicates that the coding unit uses the non-separable transform, it only indicates that the luma block corresponding to the coding unit uses the non-separable transform, and the chroma block corresponding to the coding unit does not use the non-separable transform.

A non-separable transform operation is an important transform operation. However, at present, in some scenarios, the encoding and decoding manner of the non-separable transform operation is sometimes unreasonable, which may degrade the encoding and decoding performance. Hereinafter, this problem will be described by way of example.

In ECM-11.0, coefficient(s) of the transform block can be represented by target parameters. An absolute value of a transform block coefficient is represented by accumulation and combination of target parameters. The target parameters may include, for example, one or more of the following: sig_coeff_flag, abs_level_gtx_flag, par_level_flag, abs_remainder, dec_abs_level.

The sig_coeff_flag is a flag coded based on a context model, and is used to indicate whether a coded coefficient at a current position of a transform block is zero. If a current transform block coefficient is 0, sig_coeff_flag=1.

The abs_level_gtx_flag is a flag coded based on the context model, and is used to indicate whether an absolute value of the coded coefficient at the current position of the transform block is greater than x. x is positive. In ECM-x 11.0, the values of x may be 1 and 3. Taking x=1 as an example, if the coefficient of the transform block is greater than 1, then abs_level_gt1_flag=1. Taking N=3 as an example, if the coefficient of the transform block is greater than 3, then abs_level_gt3_flag=1.

The par_level_flag is a flag coded based on the context model, and is used to indicate whether a coded coefficient at a current position of a transform block is odd or even. If the coefficient of the transform block is odd, par_level_flag=1.

The abs_remainder is a remainder syntax element that is bypass-coded using Golomb-Rice coding, and is used to indicate a remaining portion of an absolute value of a coefficient coded at a current position of a current transform block. For example, if an absolute value of a level of the transform block coefficient is greater than a second value, a fourth parameter may be used to represent a remaining absolute value of the quantized transform block coefficient.

The dec_abs_level is an absolute value of a current coefficient and is bypass coded using Golomb-Rice coding. In the process of coding and decoding coefficients of a current block, when the number of flags coded based on a context model exceeds a threshold, the remaining coefficients are no longer represented by sig_coeff_flag, abs_level_gtx_flag, par_level_flag and abs_remainder. Instead, the absolute values of the coefficients are directly coded using Golomb-Rice coding.

At the encoding end, the encoder can transform and quantize the residual information to obtain the coefficients of the transform block, and further encode the target parameters according to the coefficients of the transform block, so that the encoded target parameters can represent the coefficients of the transform block.

At the decoding end, the decoder can obtain target parameters from the bitstream, determine the coefficients of the transform block based on the values of the target parameters, and perform inverse quantization and inverse transformation on the coefficients of the transform block to obtain residual information.

Context model indexes and/or Rice parameters need to be used when target parameters are encoded and decoded. The context model index can be used to select the context model, and the Rice parameter may be a Rice parameter used in Golomb-Rice coding when abs_remainder and dec_abs_level are encoded and decoded.

The context model index and/or the Rice parameter may be determined based on neighbouring information of the transform block. Which neighbouring information is used depends on whether non-separable transform is used for the transform block. If the non-separable transform is used for the transform block, the neighbouring information is neighbouring information of the transform block in a scanning order; and if the non-separable transform is not used for the transform block, the neighbouring information is neighbouring information of the transform block in a spatial domain. For example, if the non-separable transform is used for the transform block, the context model indexes and/or Rice parameters used to encode and decode the above parameters may be determined based on neighbouring information in the scanning order. If the non-separable transform is not used for the transform block, the context model indexes and/or the Rice parameters used to encode and decode the above parameters may be determined based on the neighbouring information in the spatial domain.

The embodiments of the disclosure do not impose any specific limitation on a number of neighbouring information. For example, the neighbouring information may include information of five neighbouring positions. Of course, the neighbouring information may also include information of other number of neighbouring positions.

The neighbouring information may be information of neighbouring position(s) (or neighbouring transform block(s)) of the current transform block, and the information of the neighbouring positions may include decoded values or partially decoded values of the neighbouring positions. During determining the context model index and/or the Rice parameter, the context model index and/or the Rice parameter may be determined based on decoded values or partially decoded values of the neighbouring positions. For example, decoded values or partially decoded values of the neighbouring positions may be accumulated, and based on the accumulated value, a context model index and/or a Rice parameter may be determined.

Hereinafter, with reference to FIG. 4, a manner of determining the context model index and/or the Rice parameter will be described by taking neighbouring information including information of five neighbouring positions as an example.

Referring to FIG. 4, the left side of FIG. 4 shows five neighbouring positions in the spatial domain. If non-separable transform is not used for the transform block, the context model index and/or the Rice parameter may be derived by accumulating decoded values or partially decoded values of these five locations and using the accumulated value as a basis. The right side of FIG. 4 shows five neighbouring positions in the scanning order. If the non-separable transform is used for the transform block, the context model index and/or the Rice parameter may be derived by accumulating the decoded values or partially decoded values at these five positions and using the accumulated value as a basis.

In some scenarios (such as ECM-11.0), which neighbouring information is used for the current transform block is determined based on the LFNST ID (cu.lfnstIdx). If the LFNST ID indicates that the non-separable transform is used, the neighbouring information used for the current transform block is neighbouring information in a scanning order; and if the LFNST ID indicates that the non-separable transform is not used, the neighbouring information used for the current transform block is neighbouring information in a spatial domain. This determination manner is applicable to cases of using different partition trees for luma and chroma, but there are some problems for cases where different partition trees are not used for luma and chroma, which are analyzed below.

Since the LFNST ID is a coding unit level identifier, a luma block and a chroma block share one coding unit. For an inter-coded picture or a coded picture to which the DT division manner is not applicable, if the LFNST ID indicates that a non-separable transform is used, both the luma block and the chroma block use neighbouring information in the scanning order as the neighbouring information. However, as can be known from the foregoing description, for an inter-coded picture or a coded picture to which DT (Dual Tree) partition is not applicable, if the LFNST ID indicates that the non-separable transform is used, the LFNST ID only indicates that the luma block uses the non-separable transform, whereas the chroma block does not use the non-separable transform. Theoretically, the chroma block should use neighbouring information in a spatial domain as its neighbouring information. Therefore, if the LFNST ID is used as a condition for determining which neighbouring information to use, the chroma block will use unreasonable information to determine the coefficient of the transform block, and thus the transform performance is degraded.

Similarly, at the encoding end, for the chroma block, unreasonable information will be used to encode the coefficient of the transform block, which will degrade the transform performance.

The above is merely an example that describes an inappropriate manner of determining the transform block coefficient, and the embodiments of the disclosure are not limited thereto.

In view of the above problems, an embodiment of the disclosure provides a decoding method, including: determining first information, the first information being used for indicating whether non-separable transform is used for a current transform block; determining neighbouring information of the current transform block according to the first information; and determining a coefficient of the current transform block according to the neighbouring information.

In addition, an embodiment of the disclosure also provides an encoding method, including: determining first information, the first information being used for indicating whether non-separable transform is used for a current transform block; determining neighbouring information of the current transform block according to the first information; and encoding a coefficient of the current transform block according to the neighbouring information.

In the embodiments of the disclosure, identification information at the transform block level (that is, the first information mentioned above) is introduced to indicate whether the non-separable transform is used. Compared with the identification information at the coding block level in the related art, the identification information at the transform block level facilitates selecting appropriate neighbouring information, thereby contributing to improving the encoding and decoding performance.

The decoding method according to the embodiments of the disclosure is first described in detail by way of examples hereinafter.

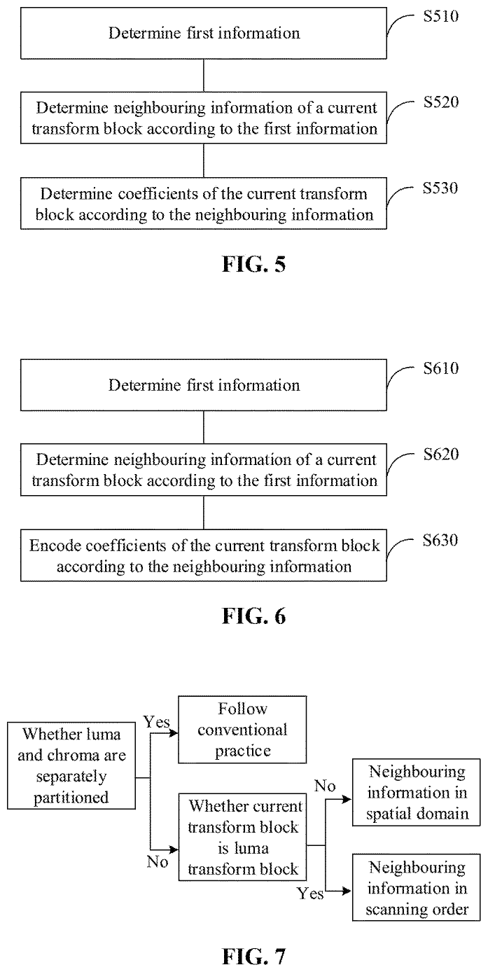

FIG. 5 is a schematic flowchart of a decoding method according to an embodiment of the disclosure. The method of FIG. 5 may be applied to a decoder.

Referring to FIG. 5, in an operation S510, first information is determined, where the first information is used for indicating whether non-separable transform is used for a current transform block. The current transform block may be a current transform block to be decoded. In some implementations, the current transform block is a luma block. In other implementations, the current transform block may also be a chroma block. The current transform block may be an inter prediction block or an intra prediction block.

The non-separable transform may be the LFNST or NSPT described above.

There are many manners of determining the first information, and the manner of determining the first information will be described in detail below.

With continued reference to FIG. 5, in an operation S520, neighbouring information of the current transform block is determined according to the first information. The neighbouring information may be, for example, neighbouring information of the current transform block in a spatial domain, or may be neighbouring information of the current transform block in a scanning order.

In some implementations, if the first information indicates that the non-separable transform is used for the current transform block, the neighbouring information of the current transform block is the neighbouring information of the current transform block in the scanning order. In other implementations, if the first information indicates that the non-separable transform is not used for the current transform block, the neighbouring information of the current transform block is the neighbouring information of the current transform block in the spatial domain.

With continued reference to FIG. 5, in an operation S530, a coefficient of the current transform block is determined according to the neighbouring information.

In the embodiments of the disclosure, the coefficient of the transform block is determined according to appropriate neighbouring information, thereby obtaining appropriate transform block coefficients, which facilitates enhancing the transform performance.

The embodiments of the disclosure do not impose any specific limitation on the determination manner in the operation S530. In some implementations, the coefficient of the current transform block may be directly obtained based on the neighbouring information. In other implementations, a context model index and/or a Rice parameter may be determined according to the neighbouring information; and the coefficient of the current transform block is then determined according to the context model index and/or Rice parameter.

The coefficient of the current transform block may be represented by target parameter(s), which may be parsed from the bitstream, and the target parameters can represent the coefficient of the current transform block through superposition and/or combination. The target parameter may include one or more of the following parameters: a first parameter, a second parameter, a third parameter, a fourth parameter, and a fifth parameter. These five parameters can represent the coefficient of the current transform block through superposition and combination. These five parameters are explained below.

The first parameter may be used for indicating whether the coefficient of the current transform block is zero, and the first parameter may also be referred to as a non-zero flag. The first parameter may be represented by the sig_coeff_flag (of course, the first parameter may also be represented by any other letters and/or numbers). If the coefficient of the current transform block is zero, the value of the first parameter may be 1; if the coefficient of the current transform block is not zero, the value of the first parameter may be 0.

The second parameter may be used for indicating whether an absolute value of the coefficient of the current transform block is greater than a first value. The second parameter may be represented by the abs_level_gtx_flag (of course, the second parameter may be represented by any other letters and/or numbers), and the first value may be x. The values of x may be 1, 2, 3, etc. If the absolute value of the coefficient of the current transform block is greater than the first value, the value of the second parameter may be 1; if the absolute value of the coefficient of the current transform block is not greater than the first value, the value of the second parameter may be 0.

The third parameter may be used for indicating parity of the absolute value of the coefficient of the current transform block. The third parameter may be represented by the par_level_flag (of course, the third parameter may be represented by any other letters and/or numbers). If the coefficient of the current transform block is odd, the value of the third parameter may be 1; if the coefficient of the current transform block is even, the value of the third parameter may be 0.

The fourth parameter may be used for representing a remainder of the coefficient of the current transform block. For example, if an absolute value of the level of the transform block coefficients is greater than a second value, the fourth parameter may be used for representing the remaining transform block coefficient. The fourth parameter may be represented by the abs_remainder (of course, the fourth parameter may also be represented by any other letters and/or numbers).

The fifth parameter may be used to represent an absolute value of the coefficient of the current transform block, and when a context model-based ID used to encode and decode the current block exceeds a threshold, the absolute value of the coefficient may be represented by directly encoding and decoding the fifth parameter. The fifth parameter may be represented by dec_abs_level (of course, the fifth parameter may be represented by any other letters and/or numbers).

The operation of determining the coefficient of the current transform block according to the context model index and/or the Rice parameter may be: decoding a target parameter in a bitstream according to the context model index and/or the Rice parameter; and determining the coefficient of the current transform block according to the target parameter. After obtaining the target parameter(s), the target parameter(s) may be superimposed and/or combined to obtain the coefficient of the transform block.

Hereinafter, a manner of determining the first information will be described.

The first information is determined based on one or more of: second information; whether a transform skip mode is used for the current transform block; whether different partition trees are used for a luma component and a chroma component; a type of the current transform block; and a type of the current coding block. The above information will be explained below.

The second information is used for indicating whether the non-separable transform is used, and the second information is information corresponding to a current coding block. Alternatively, the second information is indication information at a coding block (or coding unit) level. In some implementations, the second information may be represented by cu.lfnstIdx or lfnstIdx.

If the transform skip mode is used for the current transform block, it means that the current transform block does not undergo a transform operation, but directly undergoes a quantization operation. For example, the quantization operation may be performed directly on the residual information to obtain the coefficient of the transform block. Therefore, if the transform skip mode is used for the current transform block, it means that the non-separable transform is not used for the current transform block.

If different partition trees are used for the luma component and the chroma component, the luma component and the chroma component have respective independent coding units; If different partition trees are not used for the luma component and the chroma component, that is, the same partition tree is used for the luma component and the chroma component, the luma component and the chroma component share one coding unit. Whether different partition trees are used for the luma component and the chroma component can be determined by whether a DT partition is used for the luma component and the chroma component. If the DT partition is used for the luma component and the chroma component, different partition trees are used for the luma component and the chroma component; If the DT partition is not used for the luma component and the chroma component, different partition trees are not used for the luma component and the chroma component.

The type of the current transform block may include a chroma transform block and a luma transform block.

The type of the current encoding block may include one or more of: intra-coded block, inter-coded block, and Intra Block Copy (IBC) coded block. In the conventional scheme, the non-separable transform is only applied to intra-coded blocks, whereas the scheme in the embodiments of the disclosure can be extended to inter-coded blocks and/or IBC coded blocks.

In some implementations, the first information may be determined based on whether the transform skip mode is used for the current transform block. For example, if the transform skip mode is used for the current transform block, the first information indicates that the non-separable transform is not used for the current transform block.

In some implementations, the first information may be determined based on the second information. For example, if the second information indicates that the non-separable transform is not used, the first information indicates that the non-separable transform is not used for the current transform block.

In some implementations, the first information may be determined based on the type of the current coding block. For example, if the current coding block does not belong to the coding block of the preset type, the first information indicates that the non-separable transform is not used for the current coding block.

In some embodiments, the coding block of the preset type may be a coding block for which the non-separable transform can be used. The coding block of the preset type may include one or more of: intra-coded block, inter-coded block, and IBC coded block. Taking the coding block of the preset type that includes an intra-coded block but does not include an inter-coded block and an IBC coded block as an example, if the current coding block does not belong to the intra-coded block, that is, the current coding block belongs to the inter-coded block or the IBC coded block, the first information indicates that the non-separable transform is not used for the current coding block. Taking the coding block of the preset type that include the intra-coded block and the inter-coded block as an example, if the current coding block belongs to the IBC coded block, the first information indicates that the non-separable transform is not used for the current coding block. Taking the coding block of the preset type that include the intra-coded block and the IBC coded block as an example, if the current coding block belongs to the inter-coded block, the first information indicates that the non-separable transform is not used for the current coding block.

In some implementations, the first information may be determined based on: whether the transform skip mode is used for the current transform block, the second information, and whether different partition trees are used for the luma component and the chroma component. In some implementations, in a case where the transform skip mode is not used for the current transform block and the second information indicates that the non-separable transform mode is used, if a first condition is satisfied, the first information indicates that the non-separable transform is used for the current transform block. Herein, the first condition includes: different partition trees are used for the luma component and the chroma component. In other words, if the transform skip mode is not used for the current transform block, the second information indicates that the non-separable transform is used, and different partition trees are used for the luma component and the chroma component, then the first information indicates that the non-separable transform is used for the current transform block.

In some implementations, the first information may be determined based on: the type of the current coding block, whether the transform skip mode is used for the current transform block, the second information, and whether different partition trees are used for the luma component and the chroma component. In some implementations, in a case where the current coding block belongs to the coding block of the preset type, the transform skip mode is not used for the current transform block and the second information indicates that the non-separable transform mode is used, if a first condition is satisfied, the first information indicates that the non-separable transform is used for the current transform block. Herein, the first condition includes: different partition trees are used for the luma component and the chroma component. In other words, if the current coding block belongs to the coding block of the preset type, the transform skip mode is not used for the current transform block, the second information indicates that the non-separable transform is used, and different partition trees are used for the luma component and the chroma component, then the first information indicates that the non-separable transform is used for the current transform block.

In some implementations, the first information may be determined based on: whether the transform skip mode is used for the current transform block, the second information, whether different partition trees are used for the luma component and the chroma component, and a type of the current transform block. In some implementations, in a case where the transform skip mode is not used for the current transform block and the second information indicates that the non-separable transform mode is used, if a first condition is satisfied, the first information indicates that the non-separable transform is used for the current transform block. Herein, the first condition includes: different partition trees are not used for the luma component and the chroma component, and the current transform block is a luma block. In other words, if the transform skip mode is not used for the current transform block, the second information indicates that the non-separable transform is used, different partition trees are not used for the luma component and the chroma component, and the current transform block is the luma block, then the first information indicates that the non-separable transform is used for the current transform block (i.e., luma transform block).

In some implementations, in a case where the transform skip mode is not used for the current transform block and the second information indicates that the non-separable transform mode is used, if a second condition is satisfied, the first information indicates that the non-separable transform is not used for the current transform block. The second condition includes: different partition trees are not used for the luma component and the chroma component, and the current transform block is a chroma block. In other words, if the transform skip mode is not used for the current transform block, the second information indicates that the non-separable transform is used, different partition trees are not used for the luma component and the chroma component, and the current transform block is the chroma block, then the first information indicates that the non-separable transform is not used for the current transform block (i.e., chroma transform block).

In some implementations, the first information may be determined based on: a type of the current coding block, whether the transform skip mode is used for the current transform block, the second information, whether different partition trees are used for the luma component and the chroma component, and a type of the current transform block. In some implementations, in a case where the current coding block belongs to the coding block of the preset type, the transform skip mode is not used for the current transform block and the second information indicates that the non-separable transform mode is used, if a first condition is satisfied, the first information indicates that the non-separable transform is used for the current transform block. Herein, the first condition includes: different partition trees are not used for the luma component and the chroma component, and the current transform block is a luma block. In other words, if the current coding block belongs to the coding block of the preset type, the transform skip mode is not used for the current transform block, the second information indicates that the non-separable transform is used, different partition trees are not used for the luma component and the chroma component, and the current transform block is the luma block, then the first information indicates that the non-separable transform is used for the current transform block (i.e., luma transform block).

In some implementations, in a case where the current coding block belongs to the coding block of the preset type, the transform skip mode is not used for the current transform block and the second information indicates that the non-separable transform mode is used, if a second condition is satisfied, the first information indicates that the non-separable transform is not used for the current transform block. The second condition includes: different partition trees are not used for the luma component and the chroma component, and the current transform block is a chroma block. In other words, if the current coding block belongs to the coding block of the preset type, the transform skip mode is not used for the current transform block, the second information indicates that the non-separable transform is used, different partition trees are not used for the luma component and the chroma component, and the current transform block is the chroma block, then the first information indicates that the non-separable transform is not used for the current transform block (i.e., chroma transform block).

By determining the first information in the above manner, it is possible to accurately determine whether the non-separable transform is used for the current transform block, and thus it is possible to determine appropriate transform block coefficients, which is beneficial to improving the transform performance.

In the conventional scheme, the non-separable transform is only applied to the intra-coded block, but the embodiment of the disclosure can be applied to one or more of the intra-coded block, the inter-coded block, and the IBC coded block.

Before the second information is parsed, the type of the current transform block may also be determined. The second information is parsed when the third condition is satisfied. If the third condition is not satisfied, the second information may not be parsed.

The third condition may include that the current coding block belongs to a coding block of a preset type. The coding block of the preset type is a coding block for which the non-separable transform can be used. The coding block of the preset type may include one or more of: intra-coded block, inter-coded block, and IBC coded block.

That is, if the current coding block belongs to the coding block of the preset type, the second information may be parsed. If the current coding block does not belong to the coding block of the preset type, the second information may not be parsed.

Taking the coding block of the preset type including an intra-coded block as an example, if the coding block of the preset type includes the intra-coded block, the decoder may parse the second information when the current coding block is the intra-coded block.

Taking the coding block of the preset type including an inter-coded block as an example, if the coding block of the preset type includes the inter-coded block, the decoder may parse the second information when the current coding block is the inter-coded block.

Taking the coding block of the preset type including an IBC coded block as an example, if the coding block of the preset type includes the IBC coded block, the decoder may parse the second information when the current coding block is the IBC coded block.

If the decoder does not parse the second information, it may be inferred by default that the non-separable transform is not used for the current transform block.

After the coefficients of the transform block are obtained, the residual information can be determined according to the coefficients of the current transform block. For example, an inverse quantization and inverse transform operation may be performed on the coefficients of the current transform block to obtain residual information. An inverse transform manner used depends on whether the non-separable transform is used for the current transform block. If the non-separable transform is used for the current transform block, the inverse transform manner includes non-separable inverse transform. If the non-separable transform is not used for the current transform block, the inverse transform manner includes primary inverse transform and does not include the non-separable inverse transform.

After the residual information is obtained, the reconstruction information can be determined based on the residual information.

In some implementations, the residual information may be determined according to a transform kernel and the coefficients of the current transform block. For example, an inverse quantization operation can be performed on the coefficients of the current transform block to obtain transformed coefficients; and an inverse transform operation is performed on the transformed coefficients by utilizing a transform kernel to obtain residual information.

In some implementations, if the non-separable transform is used for the current transform block, or if the first information indicates that the non-separable transform is used for the current transform block, a transform kernel may be determined based on angular information of the current transform block. If the current transform block is an intra transform block, the transform kernel may be determined according to an intra angular direction. If the current transform block is an inter transform block or an IBC transform block, the angular information of the current transform block may be determined according to a histogram of gradients. For specific determination manners, reference can be found in the following description.

Of course, apart from using the histogram of gradients to determine the angular information of the transform block, the angular information of the transform block may also be determined in alternative ways according to the embodiments of the present disclosure. For example, a list of candidate intra prediction modes may be obtained from around the current transform block by means of template matching, and an angle may be determined by means of sorting template costs.

The decoding method according to the embodiment of the disclosure has been described in detail above with reference to FIG. 5. An encoding method according to an embodiment of the present disclosure is described in detail below with reference to FIG. 6.

FIG. 6 is a schematic flowchart of an encoding method according to an embodiment of the disclosure. The method of FIG. 6 may be applied to an encoder.

Referring to FIG. 6, in an operation S610, the first information is determined. The first information is used for indicating whether non-separable transform is used for a current transform block. The current transform block may be a current transform block to be decoded. In some implementations, the current transform block is a luma block. In other implementations, the current transform block may also be a chroma block. The current transform block may be an inter prediction block or an intra prediction block.

The non-separable transform may be LFNST or NSPT.

There are many manners of determining the first information, and the manner of determining the first information will be described in detail below.

With continued reference to FIG. 6, in an operation S620, neighbouring information of the current transform block is determined according to the first information. The neighbouring information may be, for example, neighbouring information of the current transform block in a spatial domain, or may be neighbouring information of the current transform block in a scanning order.

In some implementations, if the first information indicates that the non-separable transform is used for the current transform block, the neighbouring information of the current transform block is the neighbouring information of the current transform block in the scanning order. In other implementations, if the first information indicates that the non-separable transform is not used for the current transform block, the neighbouring information of the current transform block is the neighbouring information of the current transform block in the spatial domain.

With continued reference to FIG. 6, in an operation S630, a coefficient of the current transform block is encoded according to the neighbouring information.

In the embodiments of the disclosure, the coefficient of the transform block is encoded according to appropriate neighbouring information, thereby encoding the coefficients of the transform block using an appropriate manner, which facilitates enhancing the transform performance.

The embodiments of the disclosure do not impose any specific limitation on the encoding manner in the operation S630. In some implementations, the coefficient of the current transform block may be directly encoded based on the neighbouring information. In other implementations, a context model index and/or a Rice parameter may be determined according to the neighbouring information; and the coefficient of the current transform block is then encoded according to the context model index and/or Rice parameter.

The coefficient of the current transform block may be represented by target parameter(s), and the target parameters can represent the coefficient of the current transform block through superposition and/or combination. The target parameter may include one or more of the following parameters: a first parameter, a second parameter, a third parameter, a fourth parameter, and a fifth parameter. These five parameters can represent the coefficient of the current transform block through superposition and combination. These five parameters are explained below.

The first parameter may be used for indicating whether the coefficient of the current transform block is zero, and the first parameter may also be referred to as a non-zero flag. The first parameter may be represented by the sig_coeff_flag (of course, the first parameter may also be represented by any other letters and/or numbers). If the coefficient of the current transform block is zero, the value of the first parameter may be 1; if the coefficient of the current transform block is not zero, the value of the first parameter may be 0.

The second parameter may be used for indicating whether an absolute value of the coefficient of the current transform block is greater than a first value. The second parameter may be represented by the abs_level_gtx_flag (of course, the second parameter may be represented by any other letters and/or numbers), and the first value may be x. The values of x may be 1, 2, 3, etc. If the absolute value of the coefficient of the current transform block is greater than the first value, the value of the second parameter may be 1; if the absolute value of the coefficient of the current transform block is not greater than the first value, the value of the second parameter may be 0.

The third parameter may be used for indicating parity of the absolute value of the coefficient of the current transform block. The third parameter may be represented by the par_level_flag (of course, the third parameter may be represented by any other letters and/or numbers). If the coefficient of the current transform block is odd, the value of the third parameter may be 1; if the coefficient of the current transform block is even, the value of the third parameter may be 0.

The fourth parameter may be used for representing a remainder of the coefficient of the current transform block. For example, if an absolute value of the level of the transform block coefficients is greater than a second value, the fourth parameter may be used for representing the remaining transform block coefficient. The fourth parameter may be represented by the abs_remainder (of course, the fourth parameter may also be represented by any other letters and/or numbers).

The fifth parameter may be used to represent an absolute value of the coefficient of the current transform block, and when a context model-based ID used to encode and decode the current block exceeds a threshold, the absolute value of the coefficient may be represented by directly encoding and decoding the fifth parameter. The fifth parameter may be represented by dec_abs_level (of course, the fifth parameter may be represented by any other letters and/or numbers).

In some implementations, encoding the coefficients of the current transform block may be encoding the coefficients of the current transform block into target parameters.

In some implementation, a target parameter may be signalled according to the context model index and/or the Rice parameter, where the target parameter may be used for representing the coefficient of the current block.

Hereinafter, a manner of determining the first information will be described.

The first information is determined based on one or more of: second information; whether a transform skip mode is used for the current transform block; whether different partition trees are used for a luma component and a chroma component; a type of the current transform block; and a type of the current coding block. The above information will be explained below.

The second information is used for indicating whether the non-separable transform is used, and the second information is information corresponding to a current coding block. Alternatively, the second information is indication information at a coding block (or coding unit) level. In some implementations, the second information may be represented by cu.lfnstIdx or lfnstIdx.

If the transform skip mode is used for the current transform block, it means that the current transform block does not undergo a transform operation, but directly undergoes a quantization operation. For example, the quantization operation may be performed directly on the residual information to obtain the coefficient of the transform block. Therefore, if the transform skip mode is used for the current transform block, it means that the non-separable transform is not used for the current transform block.

If different partition trees are used for the luma component and the chroma component, the luma component and the chroma component have respective independent coding units; If different partition trees are not used for the luma component and the chroma component, that is, the same partition tree is used for the luma component and the chroma component, the luma component and the chroma component share one coding unit. Whether different partition trees are used for the luma component and the chroma component can be determined by whether a DT partition is used for the luma component and the chroma component. If the DT partition is used for the luma component and the chroma component, different partition trees are used for the luma component and the chroma component; If the DT partition is not used for the luma component and the chroma component, different partition trees are not used for the luma component and the chroma component.

The type of the current transform block may include a chroma transform block and a luma transform block.

The type of the current encoding block may include one or more of: intra-coded block, inter-coded block, and Intra Block Copy (IBC) coded block. In the conventional scheme, the non-separable transform is only applied to intra-coded blocks, whereas the scheme in the embodiments of the disclosure can be extended to inter-coded blocks and/or IBC coded blocks.

In some implementations, the first information may be determined based on whether the transform skip mode is used for the current transform block. For example, if the transform skip mode is used for the current transform block, the first information indicates that the non-separable transform is not used for the current transform block.

In some implementations, the first information may be determined based on the second information. For example, if the second information indicates that the non-separable transform is not used, the first information indicates that the non-separable transform is not used for the current transform block.

In some implementations, the first information may be determined based on the type of the current coding block. For example, if the current coding block does not belong to the coding block of the preset type, the first information indicates that the non-separable transform is not used for the current coding block.

In some embodiments, the coding block of the preset type may be a coding block for which the non-separable transform can be used. The coding block of the preset type may include one or more of: intra-coded block, inter-coded block, and IBC coded block. Taking the coding block of the preset type that includes an intra-coded block but does not include an inter-coded block and an IBC coded block as an example, if the current coding block does not belong to the intra-coded block, that is, the current coding block belongs to the inter-coded block or the IBC coded block, the first information indicates that the non-separable transform is not used for the current coding block. Taking the coding block of the preset type that include the intra-coded block and the inter-coded block as an example, if the current coding block belongs to the IBC coded block, the first information indicates that the non-separable transform is not used for the current coding block. Taking the coding block of the preset type that include the intra-coded block and the IBC coded block as an example, if the current coding block belongs to the inter-coded block, the first information indicates that the non-separable transform is not used for the current coding block.

In some implementations, the first information may be determined based on: whether the transform skip mode is used for the current transform block, the second information, and whether different partition trees are used for the luma component and the chroma component. In some implementations, in a case where the transform skip mode is not used for the current transform block and the second information indicates that the non-separable transform mode is used, if a first condition is satisfied, the first information indicates that the non-separable transform is used for the current transform block. Herein, the first condition includes: different partition trees are used for the luma component and the chroma component. In other words, if the transform skip mode is not used for the current transform block, the second information indicates that the non-separable transform is used, and different partition trees are used for the luma component and the chroma component, then the first information indicates that the non-separable transform is used for the current transform block.

In some implementations, the first information may be determined based on: the type of the current coding block, whether the transform skip mode is used for the current transform block, the second information, and whether different partition trees are used for the luma component and the chroma component. In some implementations, in a case where the current coding block belongs to the coding block of the preset type, the transform skip mode is not used for the current transform block and the second information indicates that the non-separable transform mode is used, if a first condition is satisfied, the first information indicates that the non-separable transform is used for the current transform block. Herein, the first condition includes: different partition trees are used for the luma component and the chroma component. In other words, if the current coding block belongs to the coding block of the preset type, the transform skip mode is not used for the current transform block, the second information indicates that the non-separable transform is used, and different partition trees are used for the luma component and the chroma component, then the first information indicates that the non-separable transform is used for the current transform block.

In some implementations, the first information may be determined based on: whether the transform skip mode is used for the current transform block, the second information, whether different partition trees are used for the luma component and the chroma component, and a type of the current transform block. In some implementations, in a case where the transform skip mode is not used for the current transform block and the second information indicates that the non-separable transform mode is used, if a first condition is satisfied, the first information indicates that the non-separable transform is used for the current transform block. Herein, the first condition includes: different partition trees are not used for the luma component and the chroma component, and the current transform block is a luma block. In other words, if the transform skip mode is not used for the current transform block, the second information indicates that the non-separable transform is used, different partition trees are not used for the luma component and the chroma component, and the current transform block is the luma block, then the first information indicates that the non-separable transform is used for the current transform block (i.e., luma transform block).

In some implementations, in a case where the transform skip mode is not used for the current transform block and the second information indicates that the non-separable transform mode is used, if a second condition is satisfied, the first information indicates that the non-separable transform is not used for the current transform block. The second condition includes: different partition trees are not used for the luma component and the chroma component, and the current transform block is a chroma block. In other words, if the transform skip mode is not used for the current transform block, the second information indicates that the non-separable transform is used, different partition trees are not used for the luma component and the chroma component, and the current transform block is the chroma block, then the first information indicates that the non-separable transform is not used for the current transform block (i.e., chroma transform block).

In some implementations, the first information may be determined based on: a type of the current coding block, whether the transform skip mode is used for the current transform block, the second information, whether different partition trees are used for the luma component and the chroma component, and a type of the current transform block. In some implementations, in a case where the current coding block belongs to the coding block of the preset type, the transform skip mode is not used for the current transform block and the second information indicates that the non-separable transform mode is used, if a first condition is satisfied, the first information indicates that the non-separable transform is used for the current transform block. Herein, the first condition includes: different partition trees are not used for the luma component and the chroma component, and the current transform block is a luma block. In other words, if the current coding block belongs to the coding block of the preset type, the transform skip mode is not used for the current transform block, the second information indicates that the non-separable transform is used, different partition trees are not used for the luma component and the chroma component, and the current transform block is the luma block, then the first information indicates that the non-separable transform is used for the current transform block (i.e., luma transform block).

In some implementations, in a case where the current coding block belongs to the coding block of the preset type, the transform skip mode is not used for the current transform block and the second information indicates that the non-separable transform mode is used, if a second condition is satisfied, the first information indicates that the non-separable transform is not used for the current transform block. The second condition includes: different partition trees are not used for the luma component and the chroma component, and the current transform block is a chroma block. In other words, if the current coding block belongs to the coding block of the preset type, the transform skip mode is not used for the current transform block, the second information indicates that the non-separable transform is used, different partition trees are not used for the luma component and the chroma component, and the current transform block is the chroma block, then the first information indicates that the non-separable transform is not used for the current transform block (i.e., chroma transform block).

By determining the first information in the above manner, it is possible to accurately determine whether the non-separable transform is used for the current transform block, and thus it is possible to determine appropriate transform block coefficients, which is beneficial to improving the transform performance.

In the conventional scheme, the non-separable transform is only applied to the intra-coded block, but the embodiment of the disclosure can be applied to one or more of the intra-coded block, the inter-coded block, and the IBC coded block.

Before the second information is encoded, the type of the current transform block may also be determined. The second information is encoded when the third condition is satisfied. If the third condition is not satisfied, the second information may not be encoded.

The third condition may include that the current coding block belongs to a coding block of a preset type. The coding block of the preset type is a coding block for which the non-separable transform can be used. The coding block of the preset type may include one or more of: intra-coded block, inter-coded block, and IBC coded block.

That is, if the current coding block belongs to the coding block of the preset type, the second information may be encoded. If the current coding block does not belong to the coding block of the preset type, the second information may not be encoded.

Taking the coding block of the preset type including an intra-coded block as an example, if the coding block of the preset type includes the intra-coded block, the encoder may encode the second information when the current coding block is the intra-coded block.

Taking the coding block of the preset type including an inter-coded block as an example, if the coding block of the preset type includes the inter-coded block, the encoder may encode the second information when the current coding block is the inter-coded block.

Taking the coding block of the preset type including an IBC coded block as an example, if the coding block of the preset type includes the IBC coded block, the encoder may encode the second information when the current coding block is the IBC coded block.

If the encoder does not encode the second information, it may be inferred by default that the non-separable transform is not used for the current transform block.

In some implementations, the current transform block may be transformed to determine transform coefficients. The transform manner may include primary transform, or the transform manner may include non-separable transform. For example, the transform manner may include the primary transform and the LFNST. For another example, the transform manner may include the NSPT. After the transformed coefficients are obtained, the transformed coefficients can be quantized to determine the coefficients of the current transform block.

In some implementations, the current transform block may be transformed using a transform kernel to obtain the transform coefficients.

In some implementations, if the non-separable transform is used for the current transform block, or if the first information indicates that the non-separable transform is used for the current transform block, a transform kernel may be determined based on angular information of the current transform block. If the current transform block is an intra transform block, the transform kernel may be determined according to an intra angular direction. If the current transform block is an inter transform block or an IBC transform block, the angular information of the current transform block may be determined according to a histogram of gradients. For specific determination manners, reference can be found in the following description.

Of course, apart from using the histogram of gradients to determine the angular information of the transform block, the angular information of the transform block may also be determined in alternative ways according to the embodiments of the present disclosure. For example, a list of candidate intra prediction modes may be obtained from around the current transform block by means of template matching, and an angle may be determined by means of sorting template costs.

Hereinafter, embodiments of the disclosure will be described in more detail with reference to specific examples. It is to be noted that the examples below are merely intended to help those skilled in the art understand the embodiments of the disclosure, and is not intended to limit the embodiments of the disclosure to specific numerical values or specific scenarios illustrated. It will be apparent to those skilled in the art that various equivalent modifications or variations may be made from the examples given below, and such modifications or variations also fall within the scope of the embodiments of the disclosure.

In the ECM, since the transforms such LFNST and NSPT and their inverse transform require selecting a transform kernel according to an intra angular direction, the LFNST and the NSPT are applied to a block that uses an intra prediction mode. This implies that the decoder may further determine whether to decode an lfnst_idx only when a coding unit is an intra-coded unit. The decoder obtains whether there is a transform block in the current coding unit that needs to be inversely transformed using LFNST or NSPT by parsing the syntax element lfnst_idx at the coding unit level.

When the value of the syntax element is non-zero, the current coding unit contains a transform block that needs to be inversely transformed using LFNST or NSPT, and when the value of the syntax element is zero, the transform block in the current encoding unit is free from inverse transform using LFNST or NSPT. Since the LFNST and the NSPT have an angular direction dependence, in ECM, they are used only for the transform block in the coding unit using the intra coding mode.

Regardless of whether separate tree partitions are used for luma and chroma, selection of a context model and determination of a Rice parameter during a coefficient decoding process are performed in the following manner: if lfnst_idx is 0, information at five positions in the left side of FIG. 4 is used to derive the context model and the Rice parameter; and if lfnst_idx is 1, information at five positions in the right side of FIG. 4 is used to derive the context model and the Rice parameter.

Then, the quantized transform coefficients are constructed according to the parsed syntax element, the quantized transform coefficients are inversely quantized to obtain the transform coefficients, the transform coefficients are inversely transformed according to the selected transform mode (LFNST/NSPT, or other transform mode) to obtain the residual coefficients, and the obtained residual coefficients are added to the predicted value to obtain the reconstructed block.

In VCC, the steps to decode coding unit syntax are as follows.

| | Descriptor |
|---|---|
| coding_unit (x0, y0, cbWidth, cbHeight, cqtDepth, treeType, modeType) { | |
| ... ... // decoding preceding syntax elements and processing of some preceding | |
| conditions or variables | |
| transform_tree (x0, y0, cbWidth, cbHeight, treeType, chType ) // decoding | |
| information in 7.3.11.9 transform tree | |
| if (...) { | |
| lfnst_idx | ae (v) |
| } | |
| ...... | |
| } | |
| } | |

In transform_tree( ) of VVC, syntax elements of each transform unit and syntax elements related to coefficient coding of a transform block are coded and decoded. In VVC, lfnst_idx representing an LFNST index is encoded and decoded after the transform_tree. However, in ECM (e.g., ECM-11.0), since selection of a context model and selection of a Rice parameter during encoding and decoding of transform block coefficients need to be based on a value of the lfnst_idx, the contents encoded and decoded in the transform_tree are divided into two parts. The first part includes syntax elements other than coefficient values, and the second part includes syntax elements related to the coefficient values. Therefore, in ECM-11.0, changes to the coding unit syntax table are as follows.

| | Descriptor |
|---|---|
| coding_unit (x0, y0, cbWidth, cbHeight, cqtDepth, treeType, modeType) { | |
| ... ... // decoding preceding syntax elements and processing of some preceding | |
| conditions or variables | |
| codeTuCoeff = false | |
| transform_tree (..., codeTuCoeff) // decoding information in 7.3.10.9 | |
| transform tree, where coefficient information is subsequently decoded | |
| if (...) { | |
| lfnst_idx | ae (v) |
| } | |
| codeTuCoeff = true | |
| for (tu: traverseTUs (cu)) | |
| transform_unit (..., codeTuCoeff) // decoding coefficient information in | |
| a transform unit | |
| ...... | |
| } | |
| } | |

During actual encoding and decoding of coefficients, a coding unit-level lfnst_idx may be used to determine and select a context model and determine a Rice parameter.

During derivation of the Rice parameter, a process of calculating absolute values of coefficients of five neighbouring positions is as follows.

```
locSumAbs =0
if (lfnstIdx = =0) { if lfnst_idx is zero
  ... ... // accumulating absolute values of spatial-domain neigbours
}
else {
  ... ... // accumulate absolute values in the scanning order
}
locSumAbs = Clip3 (0, 31, locSumAbs − baseLevel * 5)
```

The process of deriving the necessary variables locNumSig and locSumAbsPass1 in sig_coeff_flag, abs_level_gtx_flag, par_level_flag is as follows.

```
locNumSig =0
locSumAbsPass1=0
if (transform_skip_flag [x0] [y0] [cIdx] && !sh_ts_residual_coding_disabled_flag) {
    ... ... // variable computation under transform skip
} else {
  if (lfnstIdx = =0) {// if lfnst_idx is zero
    ... ... // accumulating spatial-domain information
}
else {
  ... ... // accumulating information in the scanning order
}
}
```

In ECM-11.0, lfnstidx was originally used to determine which adjacent information to use, but, as described above, in this manner, a case occurs in which the LFNST and the NSPT are not applied to the chroma transform block even if lfnstidx is equal to non-zero, when different partitions are not applied to the luma component and the chroma component. Therefore, in the embodiments of the present disclosure, instead of using the lfnst_idx as a condition, a variable lfnstApplied is used as a condition to determine which neighbouring information to use.

In ECM-11.0, the value of lfnstIdx is equal to the value of the coding unit syntax element lfnst_idx, whereas in the embodiments of the disclosure, the value of lfnstApplied can be obtained as follows.

IfnstApplied=(! transform_skip_flag∥sh_ts_residual_coding_disabled_flag) && IfnstIdx && (treeType!=SINGLE_TREE? true: isLuma (compID))

lfnstApplied is used to determine whether the LFNST or NSPT is used by the current transform block as the transform mode, (! transform_skip_flag∥sh_ts_residual_coding_disabled_flag) indicates that the transform skip mode is not used by the current transform block, and IfnstIdx indicates that the lfnst_idx of the current coding unit is non-zero.

(treeType!=SINGLE_TREE? true: isLuma (compID)) is used to obtain a Boolean variable (true or false). When treeType indicates different partitions for luma and chroma, the Boolean variable true is obtained. When treeType indicates the same partition for luma and chroma, it is necessary to further determine whether the colour component of the current transform block is luma. If it is a luma component, the Boolean variable true is obtained; otherwise, the Boolean variable false is obtained.

Correspondingly, during deriving of the Rice parameter, the process of calculating the sum of the absolute values of the coefficients of the five neighbouring positions is as follows.

```
locSumAbs =0
if (! lfnstApplied) {if lfnstApplied is zero
  ... ... // accumulating absolute values of spatial-domain neighbours
}
else {
  ... ... // accumulating absolute values in the scanning order
}
locSumAbs = Clip3 (0, 31, locSumAbs − baseLevel * 5)
```

The process of deriving the necessary variables locNumSig and locSumAbsPass1 in sig_coeff_flag, abs_level_gtx_flag, par_level_flag is as follows.

```
locNumSig =0
locSumAbsPass1=0
if (transform_skip_flag & &! sh_ts_residual_coding_disabled_flag) {
      ... ... // variable computation under transform skip
} else {
    if (!lfnstApplied) {// if lfnstApplied is zero
      ... ... // accumulating spatial-domain information
    }
  else {
    ... ... // accumulating information in the scanning order
    }
}
```

FIG. 7 to FIG. 10 illustrate several manners of determining neighbouring information, which are described below. The schemes of FIG. 7 to FIG. 10 are applicable to both the encoding end and the decoding end.

The scheme shown in FIG. 7 is applicable to intra-coded blocks, that is, if the current coding block is an intra-coded block, neighbouring information can be determined in the manner shown in FIG. 7.

Referring to FIG. 7, it may be determined whether the current coding block adopts separate partitions for luma and chroma. If the current coding block adopts separate partitions for luma and chroma, a conventional practice may be used. For example, neighbouring information may be determined according to lfnst_idx. If the value of lfnst_idx is 0, the neighbouring information is the neighbouring information of the current transform block in the spatial domain. If the value of lfnst_idx is not 0, the neighbouring information is the neighbouring information of the current transform block in the scanning order.

If the current coding block does not adopt separate partitions for luma and chroma, the type of the current transform block can be further determined, such as whether the current transform block is a luma transform block. If the current transform block is the luma transform block and the value of lfnst_idx is not 0, the neighbouring information is the neighbouring information of the current transform block in the scanning order. If the current transform block is a chroma transform block and the value of lfnst_idx is not 0, the neighbouring information is the neighbouring information of the current transform block in the spatial domain.

The scheme shown in FIG. 8 is applicable to a case where the non-separable transform can be used for an intra-coded block and an inter-coded block.

Referring to FIG. 8, it may be determined whether the current coding block is an intra-coded block. If the current coding block is the intra-coded block, it is further determined whether the current coding block adopts separate partitions for luma and chroma. If the current coding block adopts separate partitions for luma and chroma, a conventional practice may be used. For example, neighbouring information may be determined according to lfnst_idx. If the value of lfnst_idx is 0, the neighbouring information is the neighbouring information of the current transform block in the spatial domain. If the value of lfnst_idx is not 0, the neighbouring information is the neighbouring information of the current transform block in the scanning order.

If the current coding block does not adopt separate partitions for luma and chroma, the type of the current transform block can be further determined, such as determining whether the current transform block is a luma transform block. If the current transform block is the luma transform block and the value of lfnst_idx is not 0, the neighbouring information is the neighbouring information of the current transform block in the scanning order. If the current transform block is a chroma transform block and the value of lfnst_idx is not 0, the neighbouring information is the neighbouring information of the current transform block in the spatial domain.

If the current coding block is not an intra-coded block, it may be further determined whether the current coding block is an inter-coded block. If the current coding block is not the inter-coded block, the conventional practice may be used. If the current coding block is the inter-coded block, the type of the current transform block can be further determined, such as determining whether the current transform block is a luma transform block. If the current transform block is the luma transform block and the value of lfnst_idx is not 0, the neighbouring information is the neighbouring information of the current transform block in the scanning order. If the current transform block is a chroma transform block and the value of lfnst_idx is not 0, the neighbouring information is the neighbouring information of the current transform block in the spatial domain.

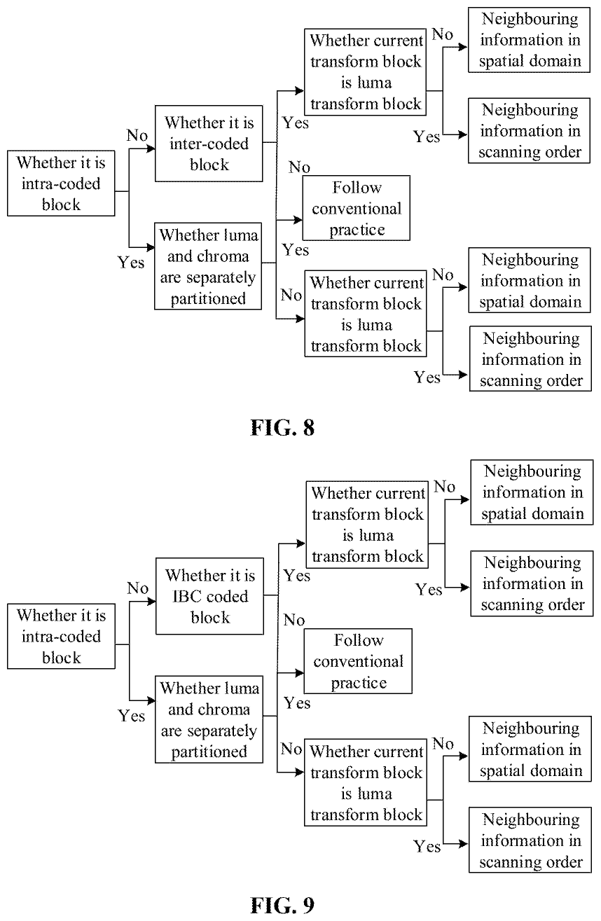

The scheme shown in FIG. 9 is applicable to a case where the non-separable transform can be used for an intra-coded block and an IBC coded block.

Referring to FIG. 9, it may be determined whether the current coding block is an intra-coded block. If the current coding block is the intra-coded block, it is further determined whether the current coding block adopts separate partitions for luma and chroma. If the current coding block adopts separate partitions for luma and chroma, a conventional practice may be used. For example, neighbouring information may be determined according to lfnst_idx. If the value of lfnst_idx is 0, the neighbouring information is the neighbouring information of the current transform block in the spatial domain. If the value of lfnst_idx is not 0, the neighbouring information is the neighbouring information of the current transform block in the scanning order.

If the current coding block does not adopt separate partitions for luma and chroma, the type of the current transform block can be further determined, such as determining whether the current transform block is a luma transform block. If the current transform block is the luma transform block and the value of lfnst_idx is not 0, the neighbouring information is the neighbouring information of the current transform block in the scanning order. If the current transform block is a chroma transform block and the value of lfnst_idx is not 0, the neighbouring information is the neighbouring information of the current transform block in the spatial domain.

If the current coding block is not an intra-coded block, it may be further determined whether the current coding block is an IBC coded block. If the current coding block is not the IBC coded block, the conventional practice may be used. If the current coding block is the IBC coded block, the type of the current transform block can be further determined, such as determining whether the current transform block is a luma transform block. If the current transform block is the luma transform block and the value of lfnst_idx is not 0, the neighbouring information is the neighbouring information of the current transform block in the scanning order. If the current transform block is a chroma transform block and the value of lfnst_idx is not 0, the neighbouring information is the neighbouring information of the current transform block in the spatial domain.

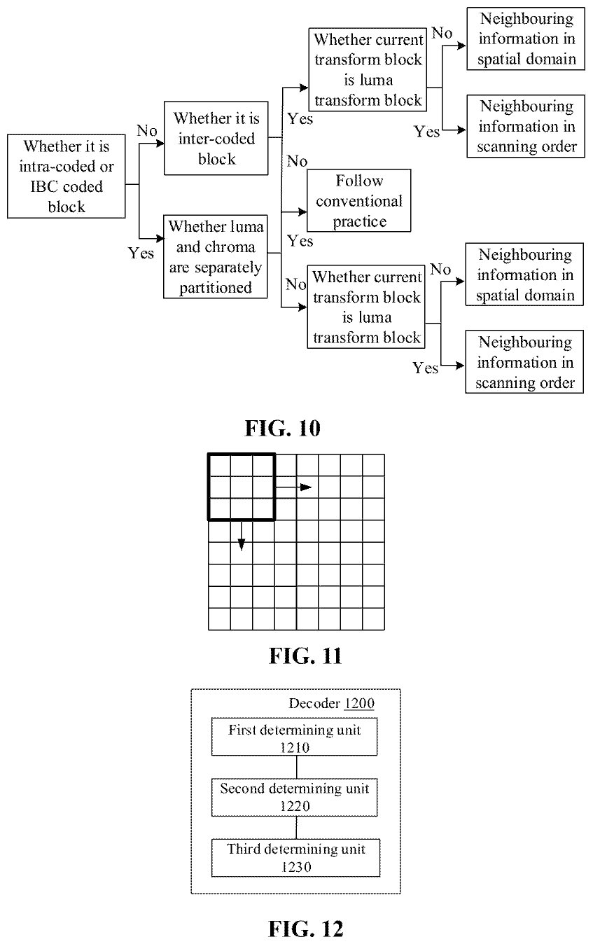

The scheme shown in FIG. 10 is applicable to a case where the non-separable transform can be used for an intra-coded block, an inter-coded block and an IBC coded block.

Referring to FIG. 10, it may be determined whether the current coding block is an intra-coded block or an IBC coded block. If the current coding block is the intra-coded block or the IBC coded block, it is further determined whether the current coding block adopts separate partitions for luma and chroma. If the current coding block adopts separate partitions for luma and chroma, a conventional practice may be used. For example, neighbouring information may be determined according to lfnst_idx. If the value of lfnst_idx is 0, the neighbouring information is the neighbouring information of the current transform block in the spatial domain. If the value of lfnst_idx is not 0, the neighbouring information is the neighbouring information of the current transform block in the scanning order.

If the current coding block does not adopt separate partitions for luma and chroma, the type of the current transform block can be further determined, such as determining whether the current transform block is a luma transform block. If the current transform block is the luma transform block and the value of lfnst_idx is not 0, the neighbouring information is the neighbouring information of the current transform block in the scanning order. If the current transform block is a chroma transform block and the value of lfnst_idx is not 0, the neighbouring information is the neighbouring information of the current transform block in the spatial domain.

If the current coding block is not the intra-coded block or the IBC coded block, it may be further determined whether the current coding block is an inter-coded block. If the current coding block is not the inter-coded block, the conventional practice may be used. If the current coding block is the inter-coded block, the type of the current transform block can be further determined, such as determining whether the current transform block is a luma transform block. If the current transform block is the luma transform block and the value of lfnst_idx is not 0, the neighbouring information is the neighbouring information of the current transform block in the scanning order. If the current transform block is a chroma transform block and the value of lfnst_idx is not 0, the neighbouring information is the neighbouring information of the current transform block in the spatial domain.

### Determination of Angular Information of the Current Transform Block

During an inverse transform, when the LFNST or the NSPT is used for the current transform block, since the LFNST and the NSPT have a characteristic of requiring joint derivation based on the lfnst_idx and an intra prediction mode, a histogram of gradients may be used to derive an angle for the current transform block. A method for calculating the angle by using the histogram of gradients is as follows.

Referring to FIG. 11, in a first step, a sliding 3×3 window is used to calculate horizontal and vertical gradient values, gₓ and g_{y}, of each 3×3 window in a prediction block. gₓ and g_{y} are obtained by calculating the dot products of a 3×3 horizontal gradient operator Mₓ and a 3×3 vertical gradient operator My with the prediction values within the window position, respectively.

$${M}_{x} = [ \begin{matrix}- 1 & 0 & 1 \\ - 2 & 0 & 2 \\ - 1 & 0 & 1\end{matrix} ] {M}_{y} = [ \begin{matrix}- 1 & - 2 & - 1 \\ 0 & 0 & 0 \\ 1 & 2 & 1\end{matrix} ]$$

Assuming that the prediction block is a block having a width and a height of (w, h), the sliding 3×3 window may be used to calculate gₓ and g_{y} at (w−2)*(h−2) positions at a center of an interpolation-filtered prediction block.

In a second step, according to gₓ and g_{y} at each position, a corresponding conventional angular direction (angle) at each position is calculated according to the following formula, and a gradient amplitude value (Amp) corresponding to the angle at each position is calculated

$$Amp = \vert {g}_{x} \vert + \vert {g}_{y} \vert and angle = a tan ( \frac{{g}_{y}}{{g}_{x}} ) .$$

In some embodiments, the calculation process of the atan may also be simplified. For example, it may be implemented by looking up a table or some variations.

In a third step, the gradient amplitude value (Amp) at each position is separately accumulated into its derived angular category to obtain a histogram of gradient amplitude values; and finally, an angle having a maximum accumulated amplitude value is selected as an angle corresponding to the current prediction block. When magnitude values derived for all angles are zero, the current block is matched to a category of a conventional PLANAR prediction mode.

In some embodiments, rather than using the prediction values of the current transform block to construct the histogram to derive the angle, it is also possible to use the reconstructed values around the current transform block to calculate the histogram of gradients and derive the angle.

In some embodiments, it is also possible that a list of candidate intra prediction modes may be obtained from around a current transform block through another manner such as template matching, and an angle used for selecting a transform kernel of LFNST or NSPT is determined by template cost sorting.

### Non-Separable Transform Applied to Inter-Coded Blocks

In some embodiments, the LFNST/NSPT may also be used in the residual transform process of the inter-coded transform block. Since an inter-coded block only exists in an inter-coded picture, and the inter-coded picture uses the same tree partition for luma and chroma by default, selection of a context model and determination of a Rice parameter during a coefficient coding and decoding process on the inter-coded block are similar to the schemes described above. In these embodiments, like intra-predicted coding units, LFNST/NSPT is used only for luma transform blocks, not for chroma transform blocks. The specific flowchart is shown in FIG. 8.

The flow of using LFNST/NSPT on an inter-coded block is as follows. At the decoder side, for an inter CU, it is determined, by parsing lfnst_idx, whether the coding unit includes a transform block using the LFNST/NSPT. Different from the conventional manner, the parsing of lfnst_idx needs to be based on whether the current coding unit is of an inter prediction type, as one of the conditions. An example of a procedure for parsing lfnst_idx in VVC the text of the standard is as follows.

| | Descriptor |
|---|---|
| coding_unit (x0, y0, cbWidth, cbHeight, cqtDepth, treeType, modeType) { | |
| ... ... // encoding and decoding of preceding coding unit-level syntax | |
| elements | |
| if (Min (lfnstWidth, lfnstHeight)> =4 && sps_lfnst_enabled_flag = =1 && | |
| (CuPredMode [chType] [x0] [y0] = = MODE_INTRA \|\| | |
| CuPredMode [chType] [x0] [y0] = = MODE_INTER) | |
| && lfnstNotTsFlag = =1 && | |
| (treeType = = DUAL_TREE_CHROMA \|! intra_mip_flag [x0] [y0] \|\| | |
| Min (lfnstWidth, lfnstHeight)> =16) && | |
| Max (cbWidth, cbHeight) <= MaxTbSizeY) { | |
| if ((IntraSubPartitionsSplitType! = ISP_NO_SPLIT \| \| LfnstDcOnly = | |
| =0) && LfnstZeroOutSigCoeffFlag ==1) | |
| lfnst_idx | ae (v) |
| } | |
| ... ...// parsing of subsequent syntax elements | |
| } | |

CuPredMode [chType] [x0] [y0]==MODE_INTRA is used to determine whether the current coding block is an intra-coded block, and CuPredMode [chType] [x0] [y0]==MODE_INTER) is used to determine whether the current coding block is an inter-coded block.

The decoder may derive the context model and Rice parameters and parse the coefficients according to the manner in FIG. 8.

### Application of Non-Separable Transform to IBC Coded Block

In some embodiments, the LFNST/NSPT may also be extended to coding units of type IBC. When an IBC-type coding unit is within a picture with a same partition for luma and chroma, the context model index and the Rice parameter in the coefficient coding process may also be determined in the manner described above, with the specific flow being similar to the processing manner used for the inter-type coding unit.

Similar to inter-type coding units, when parsing lfnst_idx, it is necessary to set whether the coding unit is of the IBC type as one of the conditions. An example of a procedure for parsing lfnst_idx in VVC the text of the standard is as follows,

| | Descriptor |
|---|---|
| coding_unit (x0, y0, cbWidth, cbHeight, cqtDepth, treeType, modeType) { | |
| ... ... // encoding and decoding of preceding coding unit-level syntax | |
| elements | |
| if (Min (lfnstWidth, lfnstHeight)> =4 && sps_lfnst_enabled_flag = =1 && | |
| (CuPredMode [chType] [x0] [y0] = = MODE_INTRA \|\| | |
| CuPredMode [chType] [x0] [y0] = = MODE_IBC) | |
| && lfnstNotTsFlag = =1 && | |
| (treeType = = DUAL_TREE_CHROMA \|! intra_mip_flag [x0] | |
| [y0] \|\| | |
| Min (lfnstWidth, lfnstHeight)> =16) && | |
| Max (cbWidth, cbHeight) <= MaxTbSizeY) { | |
| if ((IntraSubPartitionsSplitType! = ISP_NO_SPLIT \| \| LfnstDcOnly = | |
| =0) && LfnstZeroOutSigCoeffFlag ==1) | |
| lfnst_idx | ae (v) |
| } | |
| ... ... // parsing of subsequent syntax elements | |
| } | |

CuPredMode [chType] [x0] [y0]==MODE_INTRA is used to determine whether the current coding block is an intra-coded block, and CuPredMode [chType] [x0] [y0]==MODE IBC is used to determine whether the current coding block is an IBC coded block.

When the LFNST/NSPT is applied only to the IBC CU and not to the inter CU, the execution flow is shown in FIG. 9, and when the LFNST/NSPT can be applied to the IBC CU and the inter CU, the execution flow is shown in FIG. 10.

Tables 2 and 3 show the test results of the embodiments of the disclosure. Table 2 shows the test results when the scheme of the embodiment of the disclosure is used for the intra CU, and table 3 shows the test results when the scheme of the embodiment of the disclosure is used for the inter CU.

TABLE 2

| | Y | U | V | EncT | DecT |
|---|---|---|---|---|---|
| Class A1 | −0.02% | −0.01% | 0.00% | 102.6% | 98.4% |
| Class A2 | −0.01% | 0.07% | −0.01% | #NUM! | #NUM! |
| Class B | 0.02% | −0.07% | −0.05% | 104.0% | 101.1% |
| Class C | −0.01% | −0.02% | −0.07% | 104.2% | 100.0% |
| Class E | | | | | |
| Overall | 0.00% | −0.01% | −0.04% | #NUM! | #NUM! |
| Class D | −0.01% | −0.03% | 0.02% | 104.7% | 97.5% |
| Class F | −0.01% | 0.01% | −0.04% | 105.1% | 96.3% |

TABLE 3

| | Y | U | V | EncT | DecT |
|---|---|---|---|---|---|
| Class A1 | #VALUE! | #VALUE! | #VALUE! | #NUM! | #NUM! |
| Class A2 | #VALUE! | #VALUE! | #VALUE! | #NUM! | #NUM! |
| Class B | #VALUE! | #VALUE! | #VALUE! | #NUM! | #NUM! |
| Class C | 0.00% | −0.19% | −0.09% | 100.5% | 98.5% |
| Class E | | | | | |
| Overall | #VALUE! | #VALUE! | #VALUE! | #NUM! | #NUM! |
| Class D | 0.00% | −0.11% | −0.24% | 100.0% | 98.5% |
| Class F | #VALUE! | #VALUE! | #VALUE! | #DIV/0! | #DIV/0! |

As can be seen from Tables 2 and 3, after the scheme in the embodiment of the present disclosure is applied to an inter-coded block, certain improvements in coding performance can be obtained on the chroma components U and V.

Embodiments of the method of the disclosure are described in detail above with reference to FIG. 1 to FIG. 11, and embodiments of the device of the disclosure are described in detail below with reference to FIG. 12 to FIG. 15. It is to be understood that the description of the method embodiments and the description of the device embodiments correspond to each other, and therefore, for the portions not described in detail, reference can be made to the foregoing method embodiments.

FIG. 12 is a schematic structural diagram of a decoder according to an embodiment of the disclosure. As shown in FIG. 12, the decoder 1200 includes a first determining unit 1210, a second determining unit 1220, and a third determining unit 1230. The first determining unit 1210 is configured to determine first information, the first information being used for indicating whether non-separable transform is used for a current transform block; the second determining unit 1220 is configured to determine neighbouring information of the current transform block according to the first information; and the third determining unit 1230 is configured to determine a coefficient of the current transform block according to the neighbouring information.

In some implementations, the first information indicates that the non-separable transform is used for the current transform block, and the neighbouring information is neighbouring information of the current transform block in a scanning order.

In some implementations, the first information indicates that the non-separable transform is not used for the current transform block, and the neighbouring information is neighbouring information of the current transform block in a spatial domain.

In some implementations, the third determining unit 1230 is configured to determine a context model index and/or a Rice parameter according to the neighbouring information; and determine the coefficient of the current transform block according to the context model index and/or the Rice parameter.

In some implementations, the third determining unit 1230 is configured to decode a target parameter in a bitstream according to the context model index and/or the Rice parameter, the target parameter being used for representing the coefficient of the current block; and determine the coefficient of the current transform block according to the target parameter.

In some implementations, the first information is determined based on one or more of: second information for indicating whether the non-separable transform is used, and the second information being information corresponding to a current coding block; whether a transform skip mode is used for the current transform block; whether different partition trees are used for a luma component and a chroma component; a type of the current transform block; and a type of the current coding block.

In some implementations, in a case where the current coding block belongs to a coding block of a preset type, a transform skip mode is not used for the current transform block and the second information indicates that the non-separable transform mode is used, and if a first condition is satisfied, the first information indicates that the non-separable transform is used for the current transform block. Herein, the first condition includes one of: different partition trees are used for the luma component and the chroma component; and different partition trees are not used for the luma component and the chroma component, and the current transform block is a luma block.

In some implementations, in a case where the current coding block belongs to a coding block of a preset type, a transform skip mode is not used for the current transform block and the second information indicates that the non-separable transform mode is used, if a second condition is satisfied, the first information indicates that the non-separable transform is not used for the current transform block. Herein, the second condition includes: different partition trees are not used for the luma component and the chroma component, and the current transform block is a chroma block.

In some implementations, in a case where the current coding block does not belong to a coding block of a preset type, the first information indicates that the non-separable transform is not used for the current transform block.

In some implementations, the decoder 1200 further includes a parsing unit, configured to, in a case where a third condition is satisfied, parse the second information, where the third condition includes that the current coding block belongs to a coding block of a preset type.

In some implementations, the coding block of the preset type includes one or more of: intra-coded block, inter-coded block, and Intra Block Copy (IBC) coded block.

In some implementations, the decoder 1200 further includes a fourth determining unit and a fifth determining unit. The fourth determining unit is configured to determine residual information according to the coefficient of the current transform block; and the fifth determining unit is configured to determine reconstruction information according to the residual information.

In some implementations, if the first information indicates that the non-separable transform is used for the current transform block, the fourth determining unit is configured to: determine a transform kernel according to angular information of the current transform block; and determine the residual coefficient according to the transform kernel and the coefficient of the current transform block.

In some implementations, if the current coding block is an inter-coded block or an IBC coded block, the decoder further includes: a sixth determining unit, configured to determine the angular information of the current transform block using a histogram of gradients.

In some implementations, the current transform block is a luma block or a chroma block.

In some implementations, the non-separable transform is LFNST or NSPT.

It is to be understood that in the embodiments of the disclosure, the “unit” may be a part of a circuit, a part of a processor, a part of a program or software, and the like, or certainly may be a module, or may also be non-modular. Moreover, the respective components in the embodiment may be integrated into one processing unit, or each of the units may exist physically alone, or two or more units may be integrated into one unit. The integrated unit may be implemented in the form of hardware or a software function module.

If the integrated unit is implemented in the form of a software functional module and is not sold or used as an independent product, it may be stored in a computer-readable storage medium. Based on such an understanding, the technical solutions of this embodiment essentially, or the part that makes a technical contribution relative to the prior art, or all or part of the technical solutions may be embodied in the form of a software product. The computer software product is stored in a storage medium and includes a plurality of instructions for causing a computer device (which may be a personal computer, a server, a network device, or the like) or a processor to perform all or part of the operations of the methods described in the embodiments of the present disclosure. The storage medium includes various media capable of storing program codes, such as USB flash drive, mobile hard disk, Read Only Memory (ROM), Random Access Memory (RAM), magnetic disk or an optical disk.

Therefore, an embodiment of the disclosure provides a computer-readable storage medium, which applied to the decoder 1200, having stored thereon a computer program that, when executed by a processor, implements the decoding method above.

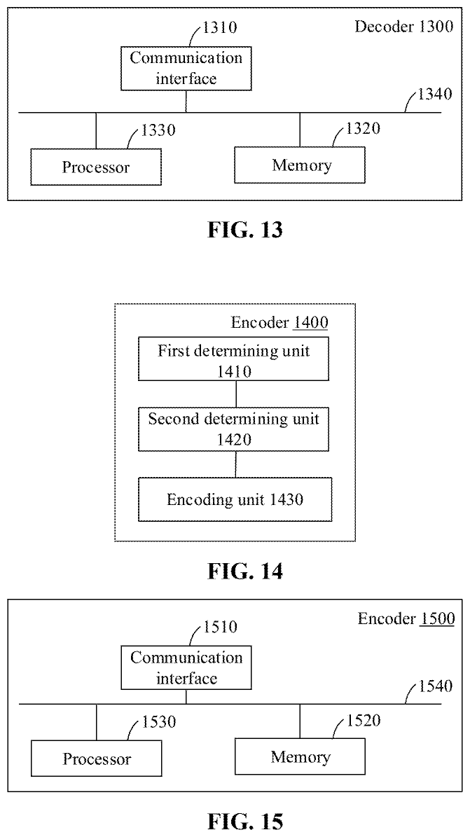

Referring to FIG. 13, based on the composition of the decoder 1200 and the computer-readable storage medium described above, it illustrates a schematic diagram showing a specific hardware structure of a decoder according to an embodiment of the disclosure. As shown in FIG. 13, the decoder 1300 may include a communication interface 1310, a memory 1320, and a processor 1330, where the various components are coupled together by a bus system 1340. It may be understood that, the bus system 1340 is configured to implement connection and communication between the components. In addition to a data bus, the bus system 1340 includes a power bus, a control bus, and a status signal bus. However, for clarity of description, various buses are marked as the bus system 1340 in FIG. 13.

The communication interface 1310 is configured to receive and send signals in the process of sending and receiving information to or from other external network element(s).

The memory 1320 is configured to store a computer program.

The processor 1330 is configured to, when running the computer program, perform:
determining first information, the first information being used for indicating whether non-separable transform is used for a current transform block;
determining neighbouring information of the current transform block according to the first information; and
determining a coefficient of the current transform block according to the neighbouring information.

It is to be understood that the memory 1320 in the embodiments of the disclosure may be either volatile memory or non-volatile memory, or may include both volatile and non-volatile memories. The non-volatile memory can be Read-Only Memory (ROM), Programmable ROM (PROM), Erasable Programmable ROM (EPROM), Electrically Erasable Programmable ROM (EEPROM), or Flash memory. The volatile memory can be Random Access Memory (RAM), which serves as external high-speed cache. By way of illustration, but not by way of limitation, many forms of RAM are available, such as Static Random Access Memory (SRAM), Dynamic Random Access Memory (DRAM), Synchronous Dynamic Random Access Memory (SDRAM), Double Data Rate Synchronous Dynamic Random Access Memory (DDR SDRAM), Enhanced Synchronous Dynamic Random Access Memory (ESDRAM), Synchlink Dynamic Random Access Memory (SLDRAM), and Direct Rambus Random Access Memory (DR RAM). The memory 1320 of the systems and methods described herein is intended to include, but is not limited to, these and any other suitable type of memory.

The processor 1330 of the embodiments of the disclosure may be an integrated circuit chip having signal processing capabilities. In the implementation process, the operations of the above-described methods may be performed by integrated logic circuits of hardware or instructions in the form of software in the processor 1330. The processor 1330 may be a general-purpose processor, a Digital Signal Processor (DSP), an Application Specific Integrated Circuit (ASIC), a Field Programmable Gate Array (FPGA) or other programmable logic device, a discrete gate or transistor logic device, or a discrete hardware component. The methods, steps, and logical block diagrams disclosed in the embodiments of the disclosure may be implemented or executed. The general-purpose processor may be a microprocessor, or the processor may be any conventional processor or the like. The steps of the method disclosed in the embodiments of the disclosure may be directly embodied as execution by a hardware decoding processor, or execution by hardware and software modules in the decoding processor. The software module may be located in a mature storage medium in the art, such as random access memory, flash memory, read-only memory, programmable read-only memory, electrically erasable and writable programmable memory, or register, etc. The storage medium is located in the memory 1320, and the processor 1330 reads information in the memory 1320, and performs the operations of the above methods in combination with its hardware.

It is to be understood that the embodiments described herein may be implemented by hardware, software, firmware, middleware, microcode, or a combination thereof. For hardware implementation, the processing unit may be implemented within one or more Application Specific Integrated Circuits (ASICs), Digital Signal Processors (DSPs), Digital Signal Processing Devices (DSPDs), Programmable Logic Devices (PLDs), Field-Programmable Gate Arrays (FPGAs), general-purpose processors, controllers, micro-controllers, microprocessors, other electronic units designed to perform the functions described in the present disclosure, or a combination thereof. For software implementation, the techniques described herein may be implemented by modules (e.g., procedures, functions, etc.) that perform the functions described herein. The software code may be stored in memory and executed by a processor. The memory may be implemented in the processor or external to the processor.

Optionally, as another embodiment, the processor 1330 is further configured to perform the decoding method described in the foregoing embodiments, when executing the computer program.

FIG. 14 is a schematic structural diagram of an encoder according to an embodiment of the disclosure. As shown in FIG. 14, the encoder 1400 includes a first determining unit 1410, a second determining unit 1420, and an encoding unit 1430. The first determining unit 1410 is configured to determine first information, the first information being used for indicating whether non-separable transform is used for a current transform block; the second determining unit 1420 is configured to determine neighbouring information of the current transform block according to the first information; and the encoding unit 1430 is configured to encode a coefficient of the current transform block according to the neighbouring information.

In some implementations, the first information indicates that the non-separable transform is used for the current transform block, and the neighbouring information is neighbouring information of the current transform block in a scanning order.

In some implementations, the first information indicates that the non-separable transform is not used for the current transform block, and the neighbouring information is neighbouring information of the current transform block in a spatial domain.

In some implementations, the encoding unit 1430 is configured to determine a context model index and/or a Rice parameter according to the neighbouring information; and encode the coefficient of the current transform block according to the context model index and/or the Rice parameter.

In some implementation, the encoding unit 1430 is configured to signal a target parameter according to the context model index and/or the Rice parameter, the target parameter being used for representing the coefficient of the current block.

In some implementations, the first information is determined based on one or more of: second information for indicating whether the non-separable transform is used, and the second information being information corresponding to a current coding block; whether a transform skip mode is used for the current transform block; whether different partition trees are used for a luma component and a chroma component; a type of the current transform block; and a type of the current coding block.

In some implementations, in a case where the current coding block belongs to a coding block of a preset type, a transform skip mode is not used for the current transform block and the second information indicates that the non-separable transform mode is used, and if a first condition is satisfied, the first information indicates that the non-separable transform is used for the current transform block. Herein, the first condition includes one of: different partition trees are used for the luma component and the chroma component; and different partition trees are not used for the luma component and the chroma component, and the current transform block is a luma block.

In some implementations, in a case where the current coding block belongs to a coding block of a preset type, a transform skip mode is not used for the current transform block and the second information indicates that the non-separable transform mode is used, if a second condition is satisfied, the first information indicates that the non-separable transform is not used for the current transform block. Herein, the second condition includes: different partition trees are not used for the luma component and the chroma component, and the current transform block is a chroma block.

In some implementations, in a case where the current coding block does not belong to a coding block of a preset type, the first information indicates that the non-separable transform is not used for the current transform block.

In some implementations, the encoding unit 1430 is configured to: in a case where a third condition is satisfied, encode the second information, where the third condition includes that the current coding block belongs to a coding block of a preset type.

In some implementations, the coding block of the preset type includes one or more of: intra-coded block, inter-coded block, and Intra Block Copy (IBC) coded block.

In some implementations, the encoder 1400 further includes a third determining unit and a fourth determining unit. The third determining unit is configured to transform the current transform block to determine a transformed coefficient; and the fourth determining unit is configured to quantize the transformed coefficient to determine the coefficient of the current transform block.

In some implementations, if the first information indicates that the non-separable transform is used for the current transform block, the third determining unit is further configured to: determine a transform kernel according to angular information of the current transform block; and transform the current transform block using the transform kernel to determine the transformed coefficient.

In some implementations, if the current transform block is an inter transform block or an IBC transform block, the encoder further includes: a fifth determining unit, configured to determine the angular information of the current transform block using a histogram of gradients.

In some implementations, the current transform block is a luma block or a chroma block.

In some implementations, the non-separable transform is LFNST or NSPT.

It is to be understood that in the embodiments of the disclosure, the “unit” may be a part of a circuit, a part of a processor, a part of a program or software, and the like, or certainly may be a module, or may also be non-modular. Moreover, the respective components in the embodiment may be integrated into one processing unit, or each of the units may exist physically alone, or two or more units may be integrated into one unit. The integrated unit may be implemented in the form of hardware or a software function module.

If the integrated unit is implemented in the form of a software functional module and is not sold or used as an independent product, it may be stored in a computer-readable storage medium. Based on such an understanding, the technical solutions of this embodiment essentially, or the part that makes a technical contribution relative to the prior art, or all or part of the technical solutions may be embodied in the form of a software product. The computer software product is stored in a storage medium and includes a plurality of instructions for causing a computer device (which may be a personal computer, a server, a network device, or the like) or a processor to perform all or part of the operations of the methods described in the embodiments of the present disclosure. The storage medium includes various media capable of storing program codes, such as USB flash drive, mobile hard disk, Read Only Memory (ROM), Random Access Memory (RAM), magnetic disk or an optical disk.

Therefore, an embodiment of the disclosure provides a computer-readable storage medium, which applied to the encoder 1400, having stored thereon a computer program that, when executed by a processor, implements the encoding methods in the embodiments above.

Referring to FIG. 15, based on the composition of the encoder 1400 and the computer-readable storage medium described above, it illustrates a schematic diagram showing a specific hardware structure of an encoder according to an embodiment of the disclosure. As shown in FIG. 15, the encoder 1500 may include a communication interface 1510, a memory 1520, and a processor 1530, where the various components are coupled together by a bus system 1540. It may be understood that, the bus system 1540 is configured to implement connection and communication between the components. In addition to a data bus, the bus system 1540 includes a power bus, a control bus, and a status signal bus. However, for clarity of description, various buses are marked as the bus system 1540 in FIG. 15.

The communication interface 1510 is configured to receive and send signals in the process of sending and receiving information to or from other external network element(s).

The memory 1520 is configured to store a computer program.

The processor 1530 is configured to, when running the computer program, perform:
determining first information, the first information being used for indicating whether non-separable transform is used for a current transform block;
determining neighbouring information of the current transform block according to the first information; and
encoding a coefficient of the current transform block according to the neighbouring information.

It can be understood that the memory 1520 in the embodiments of the disclosure may be either volatile memory or non-volatile memory, or may include both volatile and non-volatile memories. The non-volatile memory can be Read-Only Memory (ROM), Programmable ROM (PROM), Erasable Programmable ROM (EPROM), Electrically Erasable Programmable ROM (EEPROM), or Flash memory. The volatile memory can be Random Access Memory (RAM), which serves as external high-speed cache. By way of illustration, but not by way of limitation, many forms of RAM are available, such as Static Random Access Memory (SRAM), Dynamic Random Access Memory (DRAM), Synchronous Dynamic Random Access Memory (SDRAM), Double Data Rate Synchronous Dynamic Random Access Memory (DDR SDRAM), Enhanced Synchronous Dynamic Random Access Memory (ESDRAM), Synchlink Dynamic Random Access Memory (SLDRAM), and Direct Rambus Random Access Memory (DR RAM). The memory 1520 of the systems and methods described herein is intended to include, but is not limited to, these and any other suitable type of memory.

The processor 1530 of the embodiments of the disclosure may be an integrated circuit chip having signal processing capabilities. In the implementation process, the operations of the above-described methods may be performed by integrated logic circuits of hardware or instructions in the form of software in the processor 1530. The processor 1530 may be a general-purpose processor, a Digital Signal Processor (DSP), an Application Specific Integrated Circuit (ASIC), a Field Programmable Gate Array (FPGA) or other programmable logic device, a discrete gate or transistor logic device, or a discrete hardware component. The methods, steps, and logical block diagrams disclosed in the embodiments of the disclosure may be implemented or executed. The general-purpose processor may be a microprocessor, or the processor may be any conventional processor or the like. The steps of the method disclosed in the embodiments of the disclosure may be directly embodied as execution by a hardware decoding processor, or execution by hardware and software modules in the decoding processor. The software module may be located in a mature storage medium in the art, such as random access memory, flash memory, read-only memory, programmable read-only memory, electrically erasable and writable programmable memory, or register, etc. The storage medium is located in the memory 1520, and the processor 1530 reads information in the memory, and performs the operations of the above methods in combination with its hardware.

It is to be understood that the embodiments described herein may be implemented by hardware, software, firmware, middleware, microcode, or a combination thereof. For hardware implementation, the processing unit may be implemented within one or more Application Specific Integrated Circuits (ASICs), Digital Signal Processors (DSPs), Digital Signal Processing Devices (DSPDs), Programmable Logic Devices (PLDs), Field-Programmable Gate Arrays (FPGAs), general-purpose processors, controllers, micro-controllers, microprocessors, other electronic units designed to perform the functions described in the present disclosure, or a combination thereof. For software implementation, the techniques described herein may be implemented by modules (e.g., procedures, functions, etc.) that perform the functions described herein. The software code may be stored in memory and executed by a processor. The memory may be implemented in the processor or external to the processor.

Optionally, as another embodiment, the processor 1530 is further configured to perform the encoding methods described in the embodiments above, when executing the computer program.

It should be noted that in the disclosure, the terms “comprising”, “including” or any other variation thereof are intended to cover a non-exclusive inclusion such that a process, method, article or apparatus comprising a list of elements includes not only those elements, but also other elements not explicitly listed or elements inherent to such a process, method, article or apparatus. An element defined by the phrase ‘comprising an/a . . . ’ does not, without further restriction, exclude the presence of additional identical elements in a process, method, article, or apparatus that includes the element.

The above serial numbers of the embodiments of the disclosure are only for the purpose of descriptions, and do not represent advantages and disadvantages of the embodiments.

The methods disclosed in several method embodiments provided in the disclosure can be arbitrarily combined without conflict to obtain new method embodiments.

The features disclosed in several product embodiments provided in the disclosure can be arbitrarily combined without conflict to obtain new product embodiments.

The features disclosed in several method or apparatus embodiments provided in the disclosure can be arbitrarily combined without conflict to obtain new method or apparatus embodiments.

What described above are only the specific implementations of the present disclosure, but the scope of protection of the disclosure is not limited thereto. Any variation or replacement readily figured out by a person skilled in the art within the technical scope disclosed in the disclosure shall fall within the scope of protection of the disclosure. Therefore, the scope of protection of the disclosure is defined by the scope of protection of the claims.

1. A decoding method, applied to a decoder, the method comprising:
determining first information, the first information being used for indicating whether non-separable transform is used for a current transform block;
determining neighbouring information of the current transform block according to the first information; and
determining a coefficient of the current transform block according to the neighbouring information.

2. The method of claim 1, wherein the first information indicates that the non-separable transform is used for the current transform block, and the neighbouring information is neighbouring information of the current transform block in a scanning order.

3. The method of claim 1, wherein the first information indicates that the non-separable transform is not used for the current transform block, and the neighbouring information is neighbouring information of the current transform block in a spatial domain.

4. The method of claim 1, wherein determining the coefficient of the current transform block according to the neighbouring information comprises:
determining a context model index and/or a Rice parameter according to the neighbouring information; and
determining the coefficient of the current transform block according to the context model index and/or the Rice parameter.

5. The method of claim 4, wherein determining the coefficient of the current transform block according to the context model index and/or the Rice parameter comprises:
decoding a target parameter in a bitstream according to the context model index and/or the Rice parameter, the target parameter being used for representing the coefficient of the current block; and
determining the coefficient of the current transform block according to the target parameter.

6. The method of claim 1, wherein the first information is determined based on one or more of:
second information for indicating whether the non-separable transform is used, and the second information being information corresponding to a current coding block;
whether a transform skip mode is used for the current transform block;
whether different partition trees are used for a luma component and a chroma component;
a type of the current transform block; and
a type of the current coding block.

7. The method of claim 6, wherein in a case where the current coding block belongs to a coding block of a preset type, a transform skip mode is not used for the current transform block and the second information indicates that the non-separable transform mode is used, and if a first condition is satisfied, the first information indicates that the non-separable transform is used for the current transform block, wherein the first condition comprises one of:
different partition trees are used for the luma component and the chroma component; and
different partition trees are not used for the luma component and the chroma component, and the current transform block is a luma block.

8. The method of claim 6, wherein in a case where the current coding block belongs to a coding block of a preset type, a transform skip mode is not used for the current transform block and the second information indicates that the non-separable transform mode is used, if a second condition is satisfied, the first information indicates that the non-separable transform is not used for the current transform block, wherein the second condition comprises: different partition trees are not used for the luma component and the chroma component, and the current transform block is a chroma block.

9. The method of claim 7, wherein the coding block of the preset type comprises one or more of: intra-coded block, inter-coded block, and Intra Block Copy (IBC) coded block.

10. The method of claim 1, further comprising:
determining residual information according to the coefficient of the current transform block; and
determining reconstruction information according to the residual information.

11. The method of claim 1, wherein the non-separable transform is Low-Frequency Non-Separable Transform (LFNST) or Non-Separable Primary Transform (NSPT).

12. An encoding method, applied to an encoder, the method comprising:
determining first information, the first information being used for indicating whether non-separable transform is used for a current transform block;
determining neighbouring information of the current transform block according to the first information; and
encoding a coefficient of the current transform block according to the neighbouring information.

13. The method of claim 12, wherein the first information indicates that the non-separable transform is used for the current transform block, and the neighbouring information is neighbouring information of the current transform block in a scanning order.

14. The method of claim 12, wherein the first information indicates that the non-separable transform is not used for the current transform block, and the neighbouring information is neighbouring information of the current transform block in a spatial domain.

15. The method of claim 12, wherein encoding the coefficient of the current transform block according to the neighbouring information comprises:
determining a context model index and/or a Rice parameter according to the neighbouring information; and
encoding the coefficient of the current transform block according to the context model index and/or the Rice parameter.

16. The method of claim 15, wherein encoding the coefficient of the current transform block according to the context model index and/or the Rice parameter comprises:
signalling a target parameter according to the context model index and/or the Rice parameter, the target parameter being used for representing the coefficient of the current block.

17. The method of claim 12, wherein the first information is determined based on one or more of:
second information for indicating whether the non-separable transform is used, and the second information being information corresponding to a current coding block;
whether a transform skip mode is used for the current transform block;
whether different partition trees are used for a luma component and a chroma component;
a type of the current transform block; and
a type of the current coding block.

18. The method of claim 17, wherein in a case where the current coding block belongs to a coding block of a preset type, a transform skip mode is not used for the current transform block and the second information indicates that the non-separable transform mode is used, and if a first condition is satisfied, the first information indicates that the non-separable transform is used for the current transform block, wherein the first condition comprises one of:
different partition trees are used for the luma component and the chroma component; and
different partition trees are not used for the luma component and the chroma component, and the current transform block is a luma block.

19. The method of claim 17, wherein in a case where the current coding block belongs to a coding block of a preset type, a transform skip mode is not used for the current transform block and the second information indicates that the non-separable transform mode is used, if a second condition is satisfied, the first information indicates that the non-separable transform is not used for the current transform block, wherein the second condition comprises: different partition trees are not used for the luma component and the chroma component, and the current transform block is a chroma block.

20. A non-transitory computer-readable storage medium having stored thereon a computer program and a bitstream, wherein when the computer program is executed by a processor, the computer program implements a decoding method to decode the bitstream to generate a video or an image, and the decoding method comprises:
determining first information, the first information being used for indicating whether non-separable transform is used for a current transform block;
determining neighbouring information of the current transform block according to the first information; and
determining a coefficient of the current transform block according to the neighbouring information.
